(19) United States
(12) Patent Application Publication
(10) Pub. No.: US 2021/0399925 A1
(43) Pub. Date: Dec. 23, 2021

(54) SIGNAL TRANSMISSION DEVICE CAPABLE OF TRANSMITTING MULTIPLE DATA STREAMS

(71) Applicant: REALTEK SEMICONDUCTOR CORP., Hsinchu (TW)

(72) Inventors: An-Ming Lee, Hsinchu (TW); Bo-Kai Huang, Hsinchu (TW)

(73) Assignee: REALTEK SEMICONDUCTOR CORP., Hsinchu (TW)

(21) Appl. No.: 17/339,181

(22) Filed: Jun. 4, 2021

Related U.S. Application Data
(60) Provisional application No. 63/040,148, filed on Jun. 17, 2020.

(30) Foreign Application Priority Data
Aug. 13, 2020 (TW) 109127629
Mar. 19, 2021 (TW) 110110117

(51) Int. Cl. H04L 25/02; G06F 13/40; G06F 13/42

(52) U.S. Cl. CPC H04L 25/0272; G06F 13/4282; G06F 13/4068

(57) ABSTRACT

A signal transmission device is provided, including a plurality of positive differential pins, a plurality of negative differential pins, a plurality of ground pins, a plurality of power signal pins, and a plurality of control signal pins. A first positive differential pin of the plurality of positive differential pins transmits a positive signal content of a first differential signal. A second positive differential pin transmits a positive signal content of a second differential signal. A first negative differential pin of the plurality of negative differential pins transmits a negative signal content of the first differential signal. A second negative differential pin transmits a negative signal content of the second differential signal. The first positive differential pin and the first negative differential pin are located on one side of a first ground pin, and the second positive differential pin and the second negative differential pin are located on the other side.

### CROSS-REFERENCES TO RELATED APPLICATIONS

This application claims the benefit of U.S. provisional application Ser. No. 63/040,148, filed on Jun. 17, 2020, claims the priority of Patent Application No. 109127629 filed in Taiwan, R.O.C. on Aug. 13, 2020, and Patent Application No. 110110117 filed in Taiwan, R.O.C. on Mar. 19, 2021. The entirety of the above-mentioned patent applications are hereby incorporated by references herein and made a part of the specification.

### BACKGROUND

### Technical Field

The present disclosure relates to a signal transmission device capable of transmitting a plurality of data streams.

### Related Art

As quality requirements on playing-back video and pictures become increasingly higher from original resolution of 4K to the resolution of 8K, an amount of data required to be transmitted from a player as a signal source to a display as a signal sink also increases. In addition, due to the emergence of home theaters, a longer transmission line is required to connect between the signal source and the signal sink to meet various needs of arrangement in living rooms.

In current signal transmission device specifications, the definition of pin positions, ground shielding, which is important for differential signals, is not the best planning manner, which makes signal quality easily affected by crosstalk and delay during high-speed transmission of signals, failing to achieve reliable transmission at a long distance.

### SUMMARY

In some embodiments, a signal transmission device comprises a plurality of positive differential pins, a plurality of negative differential pins, a plurality of ground pins, a plurality of power signal pins, and a plurality of control signal pins. A first positive differential pin of the plurality of positive differential pins is configured to transmit a positive signal content of a first differential signal, and a second positive differential pin of the plurality of positive differential pins is configured to transmit a positive signal content of a second differential signal. A first negative differential pin of the plurality of negative differential pins is configured to transmit a negative signal content of the first differential signal, and a second negative differential pin of the plurality of negative differential pins is configured to transmit a negative signal content of the second differential signal. The first positive differential pin and the first negative differential pin are located on one side of a first ground pin of the plurality of ground pins, and the second positive differential pin and the second negative differential pin are located on the other side of the first ground pin.

### BRIEF DESCRIPTION OF THE DRAWINGS

FIG. 1 is a schematic diagram of an embodiment of a signal transmission device according to the disclosure.

FIG. 2 is a schematic diagram of another embodiment of the signal transmission device in FIG. 1.

FIG. 3 is a schematic diagram of an embodiment of a pin arrangement of the signal transmission device according to the disclosure.

FIG. 4 is a schematic diagram of an embodiment of a pin arrangement of the signal transmission device according to the disclosure.

FIG. 5A is a schematic appearance diagram of an embodiment of a female connector of the signal transmission device according to the disclosure.

FIG. 5B is a schematic appearance diagram of an embodiment of a male connector of the signal transmission device corresponding to FIG. 5A.

FIG. 5C is a schematic side view of an embodiment of the signal transmission device in FIG. 5A.

FIG. 5D is a schematic side view of an embodiment of the signal transmission device in FIG. 5B.

FIG. 6A is a schematic side view of another embodiment of the female connector of the signal transmission device according to the disclosure.

FIG. 6B is a schematic side view of another embodiment of the male connector of the signal transmission device corresponding to FIG. 6A.

FIG. 7A is a schematic side view of another embodiment of the female connector of the signal transmission device according to the disclosure.

FIG. 7B is a schematic side view of another embodiment of the male connector of the signal transmission device corresponding to FIG. 7A.

FIG. 8A illustrates a schematic appearance diagram of another embodiment of the female connector of the signal transmission device according to the disclosure.

FIG. 8B illustrates a schematic side view of another embodiment of the female connector of the signal transmission device corresponding to FIG. 8A.

FIG. 8C illustrates a schematic appearance diagram of another embodiment of the mal connector of the signal transmission device corresponding to FIG. 8A.

FIG. 8D illustrates a schematic side view of another embodiment of the signal transmission device corresponding to FIG. 8C.

FIG. 8E illustrates a schematic appearance diagram of one embodiment showing that the female connector of the signal transmission device corresponding to FIG. 8A is mated with the male connector of the signal transmission device corresponding to FIG. 8C.

FIG. 8F illustrates a schematic top view of one embodiment of the female connector of the signal transmission device corresponding to FIG. 8A and the male connector of the signal transmission device corresponding to FIG. 8C.

FIG. 9 illustrates a schematic top view of another embodiment of the female connector and the male connector of the signal transmission device according to the disclosure.

FIG. 10 illustrates a schematic top view of another embodiment of the female connector and the male connector of the signal transmission device according to the disclosure.

FIG. 11 illustrates a schematic top view of another embodiment of the female connector and the male connector of the signal transmission device according to the disclosure.

FIG. 12 is a schematic diagram of an embodiment of a transmission line including a signal transmission device and an electronic device according to the disclosure.

FIG. 13A and FIG. 13B are respectively schematic diagrams of another embodiment of the signal transmission device according to the disclosure.

FIG. 14A and FIG. 14B are respectively schematic diagrams of another embodiment of the signal transmission device in FIG. 13A and FIG. 13B.

FIG. 15A and FIG. 15B are respectively schematic diagrams of one embodiment of the signal transmission device according to the disclosure.

FIG. 16A and FIG. 16B are respectively schematic diagrams of one embodiment of the signal transmission device according to the disclosure.

FIG. 17A and FIG. 17B are respectively schematic diagrams of one embodiment of the signal transmission device according to the disclosure.

FIG. 18A and FIG. 18B are respectively schematic diagrams of one embodiment of the signal transmission device according to the disclosure.

FIG. 19A and FIG. 19B are respectively schematic diagrams of one embodiment of the signal transmission device according to the disclosure.

FIG. 20A and FIG. 20B are respectively schematic diagrams of one embodiment of the signal transmission device according to the disclosure.

### DETAILED DESCRIPTION

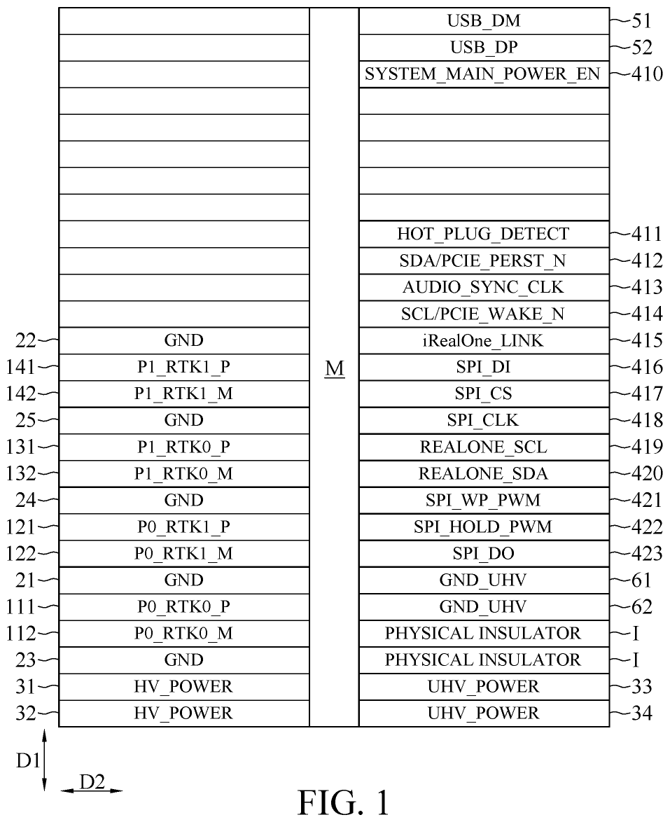

Referring to FIG. 1, FIG. 1 is a schematic diagram of an embodiment of a signal transmission device according to the disclosure. The signal transmission device comprises a plurality of positive differential pins, a plurality of negative differential pins, a plurality of control signal pins, a plurality of ground pins, and a plurality of power signal pins. A number of positive differential pins, a number of negative differential pins, a number of ground pins, a number of power signal pins, and a number of control signal pins may be customized based on different product requirements (for example, required current and signal transmission rate). FIG. 1 only illustrates one embodiment of the signal transmission device, and the disclosure is not limited thereto.

FIG. 1 illustrates a plurality of positive differential pins 111, 121, 131, and 141, a plurality of negative differential pins 112, 122, 132, and 142, and a plurality of ground (GND) pins 21 to 25 corresponding to the differential pins 111, 112, 121, 122, 131, 132, 141, and 142. The positive differential pins 111, 121, 131, and 141 and the negative differential pins 112, 122, 132, and 142 respectively transmit a positive signal content and a negative signal content of a differential signal. The positive differential pins 111 and 121 (referred to as a first positive differential pin 111 and a second positive differential pin 121 for ease of description), the negative differential pins 112 and 122 (respectively referred to as a first negative differential pin 112 and a second negative differential pin 122), and the corresponding ground pin 21 (referred to as a first ground pin 21 below) are first used as an example for description herein.

The first positive differential pin 111 and the first negative differential pin 112 transmit a first differential signal. The first positive differential pin 111 transmits a positive signal content of the first differential signal, and the first negative differential pin 112 transmits a negative signal content of the first differential signal. The second positive differential pin 121 and the second negative differential pin 122 transmit another differential signal different from the first differential signal (referred to as a second differential signal below). The second positive differential pin 121 transmits a positive signal content of the second differential signal, and the second negative differential pin 122 transmits a negative signal content of the second differential signal. In terms of configuration, the first positive differential pin 111 and the first negative differential pin 112 are located on one side of the first ground pin 21 (that is, the two differential pins 111 and 112 that transmit the same differential signal are located on the same side of the first ground pin 21), and the second positive differential pin 121 and the second negative differential pin 122 are located on the other side of the first ground pin 21 (that is, the two differential pins 121 and 122 that transmit the same differential signal are located on the same side of the first ground pin 21), that is, the two differential pins 111 and 122 that transmit different differential signals are located on different sides of the first ground pin 21.

Furthermore, FIG. 1 illustrates four power signal pins 31 to 34 and a plurality of control signal pins. The power signal pins 31 to 34 can transmit power signals complying with specific communication specifications, and the control signal pins can transmit control signals complying with specific communication specifications. In other words, in addition to the differential signal, the signal transmission device can further transmit the power signal and control signal for operation of an electronic device, and the power signal and control signal comply with specific communication specifications. Based on this, different from a conventional signal transmission device, the signal transmission device in the disclosure can avoid crosstalk between the different differential signals during transmission of the first differential signal and the second differential signal, and obtain better impedance matching characteristics, so that transmission quality of the signal transmission device is improved, and the signal can be transmitted to the electronic device more efficient.

In some embodiments, as shown in FIG. 1, the signal transmission device can transmit at least four pairs of differential signals, and a third positive differential pin 131 and a third negative differential pin 132 can transmit a third differential signal. The third positive differential pin 131 transmits a positive signal content of the third differential signal, and the third negative differential pin 132 transmits a negative signal content of the third differential signal. A fourth positive differential pin 141 and a fourth negative differential pin 142 can transmit a fourth differential signal. The fourth positive differential pin 141 transmits a positive signal content of the fourth differential signal, and the fourth negative differential pin 142 transmits a negative signal content of the fourth differential signal. In order to prevent the above four pairs of differential signals from interfering with each other, as shown in FIG. 1, the plurality of ground pins of the signal transmission device are the first ground pin 21, a second ground pin 22, a third ground pin 23, a fourth ground pin 24, and a fifth ground pin 25. The second positive differential pin 121 and the second negative differential pin 122 are located between the first ground pin 21 and the fourth ground pin 24, that is, the second positive differential pin 121 and the second negative differential pin 122 are located on one side of the fourth ground pin 24, and the third positive differential pin 131 and the third negative differential pin 132 are located on the other side of the fourth ground pin 24. The third positive differential pin 131 and the third negative differential pin 132 are located between the fourth ground pin 24 and the fifth ground pin 25, that is, the third positive differential pin 131 and the third negative differential pin 132 are located on one side of the fifth ground pin 25, and the fourth positive differential pin 141 and the fourth negative differential pin 142 are located on the other side of the fifth ground pin 25. Based on this, the second positive differential pin 121 and the third negative differential pin 132 are shielded by the fourth ground pin 24, and the third positive differential pin 131 and the fourth negative differential pin 142 are shielded by the fifth ground pin 25. The first differential signal, the second differential signal, the third differential signal, and the fourth differential signal do not interfere with each other.

In some embodiments, the plurality of positive differential pins 111, 121, 131, and 141 and the plurality of negative differential pins 112, 122, 132, and 142 are arranged along a same linear direction D1 (for example, a comparatively longer direction of the signal transmission device), so that the signal transmission device can be more easily compatible with existing communication transmission specifications.

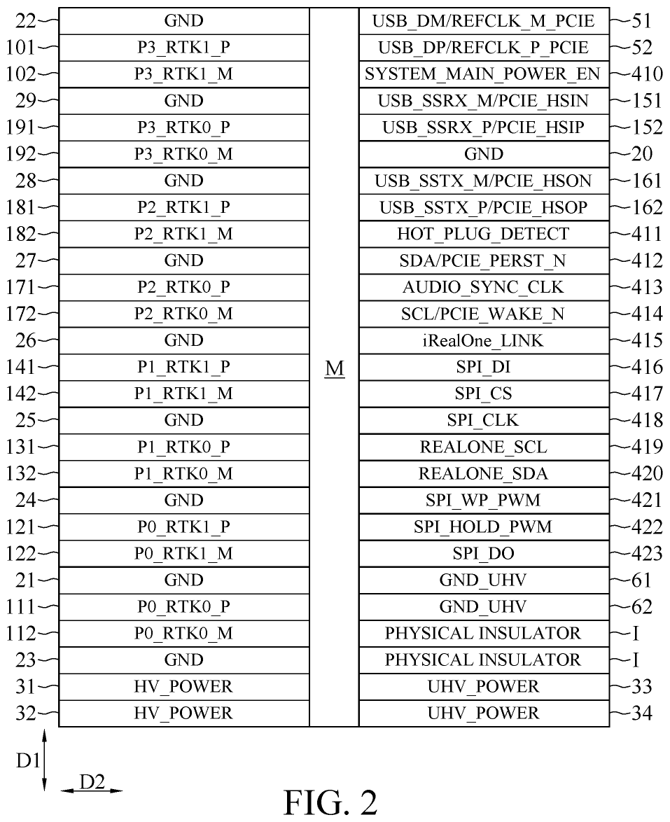

In some embodiments, referring to FIG. 2, FIG. 2 is a schematic diagram of another embodiment of the signal transmission device in FIG. 1. The signal transmission device may also include eight pairs of differential pins, and each pair of differential pins that transmit a same differential signal is shielded by two ground pins. The signal transmission device further includes positive differential pins 171, 181, 191, and 101 (respectively referred to as a seventh positive differential pin 171, an eighth positive differential pin 181, a ninth positive differential pin 191, and a tenth positive differential pins 101 below), negative differential pins 172, 182, 192, and 102 (respectively referred to as a seventh negative differential pin 172, an eighth negative differential pin 182, a ninth negative differential pin 192, and a tenth negative differential pin 102 below), and corresponding ground pins 26, 27, 28, and 29. The positive differential pins 171, 181, 191, and 101 and the negative differential pins 172, 182, 192, and 102 are also arranged along the same linear direction D1. The seventh positive differential pin 171 and the seventh negative differential pin 172 can transmit a seventh differential signal. The seventh positive differential pin 171 transmits a positive signal content of the seventh differential signal, and the seventh negative differential pin 172 transmits a negative signal content of the seventh differential signal. The eighth positive differential pin 181 and the eighth negative differential pin 182 can transmit an eighth differential signal. The eighth positive differential pin 181 transmits a positive signal content of the eighth differential signal, and the eighth negative differential pin 182 transmits a negative signal content of the eighth differential signal. The ninth positive differential pin 191 and the ninth negative differential pin 192 can transmit a ninth differential signal. The ninth positive differential pin 191 transmits a positive signal content of the ninth differential signal, and the ninth negative differential pin 192 transmits a negative signal content of the ninth differential signal. The tenth positive differential pin 101 and the tenth negative differential pin 102 can transmit a tenth differential signal. The tenth positive differential pin 101 transmits a positive signal content of the tenth differential signal, and the tenth negative differential pin 102 transmits a negative signal content of the tenth differential signal.

In order to prevent the above eight differential signals from interfering with each other, as shown in FIG. 2, the fourth positive differential pin 141 and the fourth negative differential pin 142 are located between the fifth ground pin 25 and the sixth ground pin 26, that is, the fourth positive differential pin 141 and the fourth negative differential pin 142 are located on one side of the sixth ground pin 26, and the seventh positive differential pin 171 and the seventh negative differential pin 172 are located on the other side of the sixth ground pin 26. The seventh positive differential pin 171 and the seventh negative differential pin 172 are located between the sixth ground pin 26 and the seventh ground pin 27, that is, the seventh positive differential pin 171 and the seventh negative differential pin 172 are located on one side of the seventh ground pin 27, and the eighth positive differential pin 181 and the eighth negative differential pin 182 are located on the other side of the seventh ground pin 27. The eighth positive differential pin 181 and the eighth negative differential pin 182 are located between the seventh ground pin 27 and the eighth ground pin 28, that is, the eighth positive differential pin 181 and the eighth negative differential pin 182 are located on one side of the eighth ground pin 28, and the ninth positive differential pin 191 and the ninth negative differential pin 192 are located on the other side of the eighth ground pin 28. The ninth positive differential pin 191 and the ninth negative differential pin 192 are located between the eighth ground pin 28 and the ninth ground pin 29, that is, the ninth positive differential pin 191 and the ninth negative differential pin 192 are located on one side of the ninth ground pin 29, and the tenth positive differential pin 101 and the tenth negative differential pin 102 are located on the other side of the ninth ground pin 29. Based on this, the fourth positive differential pin 141 and the seventh negative differential pin 172 are shielded by the sixth ground pin 26, the seventh positive differential pin 171 and the eighth negative differential pin 182 are shielded by the seventh ground pin 27, the eighth positive differential pin 181 and the ninth negative differential pin 192 are shielded by the eighth ground pin 28, and the ninth positive differential pin 191 and the tenth negative differential pin 102 are shielded by the ninth ground pin 29. The first differential signal, the second differential signal, the third differential signal, the fourth differential signal, the seventh differential signal, the eighth differential signal, the ninth differential signal, and the tenth differential signal do not interfere with each other. Based on this, the signal transmission device can transmit at least eight pairs of differential signals. The eight pairs of differential pins are arranged along the same linear direction D1, so that the signal transmission device can be more easily compatible with the existing communication transmission specifications.

In some embodiments, as shown in FIG. 1 and FIG. 2, on one side of the third ground pin 23 of the plurality of ground pins (that is, the side far from the first negative differential pin 112), no positive differential pin and negative differential pin are disposed, but the power signal pins 31 and 32 may be disposed. In addition, the first positive differential pin 111 and the first negative differential pin 112 are on the other side of the third ground pin 23, that is, the first positive differential pin 111 and the first negative differential pin 112 are located between the first ground pin 21 and the third ground pin 23. The first positive differential pin 111 and the first negative differential pin 112 are shielded by two ground pins 21 and 23. The ground pins 21 and 23 can jointly provide first differential signal ground. Based on this, the third ground pin 23 is disposed to isolate the first positive differential pin 111 and the first negative differential pin 112 from the plurality of power signal pins 31 and 32, so that transmission quality of the first differential signal can be prevented from degrading as a result of interference of a power signal during transmission of the first differential signal by the first positive differential pin 111 and the first negative differential pin 112.

In some embodiments, as shown in FIG. 2, the second ground pin 22 is located at an extreme edge position of the signal transmission device, that is, no positive differential pin and negative differential pin are disposed on one side of the second ground pin 22 in the linear direction D1, and the tenth positive differential pin 101 and the tenth negative differential pin 102 on the other side of the second ground pin 22 in the linear direction D1. In other words, the tenth positive differential pin 101 and the tenth negative differential pin 102 are located between the ninth ground pin 29 and the second ground pin 22, and the tenth positive differential pin 101 and the tenth negative differential pin 102 are shielded by the two ground pins 29 and 22, that is, the ground pins 29 and 22 can jointly provide tenth differential signal ground. Based on this, transmission quality of the tenth differential signal can be further prevented from degrading as a result of interference of noise outside the signal transmission device during transmission of the tenth differential signal by the tenth positive differential pin 101 and the tenth negative differential pin 102.

In some embodiments, as shown in FIG. 2, the plurality of differential pins of the signal transmission device further include two positive differential pins 151 and 161 and two negative differential pins 152 and 162 (the positive differential pins 151 and 161 are respectively referred to as a first positive differential high-speed pin 151 and a second positive differential high-speed pin 161, and the negative differential pins 152 and 162 are respectively referred to as a first negative differential high-speed pin 152 and a second negative differential high-speed pin 162 below), and the plurality of ground pins of the signal transmission device further include a tenth ground pin 20. The first positive differential high-speed pin 151 is configured to transmit a positive signal content of a fifth differential signal, and the first negative differential high-speed pin 152 is configured to transmit a negative signal content of the fifth differential signal. The second positive differential high-speed pin 161 is configured to transmit a positive signal content of a sixth differential signal, and the second negative differential high-speed pin 162 is configured to transmit a negative signal content of the sixth differential signal. In terms of configuration, the first positive differential high-speed pin 151 and the first negative differential high-speed pin 152 are located on one side of the tenth ground pin 20, the second positive differential high-speed pin 161 and the second negative differential high-speed pin 162 are located on the other side of the tenth ground pin 20, and the positive differential high-speed pins 151 and 161, the tenth ground pin 20, and the negative differential high-speed pins 152 and 162 are arranged along the same linear direction D1.

In some embodiments, the plurality of positive differential pins and the plurality of negative differential pins of the signal transmission device are configured to transmit high-speed signals. For example, the first differential signal transmitted by the differential pins 111 and 112, the second differential signal transmitted by the differential pins 121 and 122, the third differential signal transmitted by the differential pins 131 and 132, the fourth differential signal transmitted by the differential pins 141 and 142, the seventh differential signal transmitted by the differential pins 171 and 172, the eighth differential signal transmitted by the differential pins 181 and 182, the ninth differential signal transmitted by the differential pins 191 and 192, the tenth differential signal transmitted by the differential pins 101 and 102, the fifth differential signal transmitted by the differential high-speed pins 151 and 152, and the sixth differential signal transmitted by the differential high-speed pins 161 and 162 are all high-speed signals. In addition, as shown in FIG. 1 and FIG. 2, the signal transmission device may further include a positive differential low-speed pin 51 and a negative differential low-speed pin 52 configured to transmit a low-speed data signal. The positive differential low-speed pin 51 and the negative differential low-speed pins 52 and the differential high-speed pins 151, 152, 161, and 162 are arranged along the same straight line direction D1. The positive differential low-speed pin 51 and the negative differential low-speed pin 52 transmit a low-speed differential signal of low-speed data. The positive differential low-speed pin 51 transmits a positive signal content of the low-speed differential signal, and the negative differential low-speed pin 52 transmits a negative signal content of the low-speed differential signal. Based on this, the signal transmission device can simultaneously support transmission of high-speed signals and low-speed data signals.

In some embodiments, the signal transmission device illustrated in FIG. 1 to FIG. 2 can support universal serial bus (USB) 2.0 specifications. The positive differential low-speed pin 51 and the negative differential low-speed pin 52 are adapted to the USB 2.0 specifications. The low-speed differential signal transmitted by the positive differential low-speed pin 51 and the negative differential low-speed pin 52 is a USB signal of USB 2.0. The positive differential low-speed pin 51 can transmit a USB-DP signal, and the negative differential low-speed pin 52 can transmit a USB-DM signal. Furthermore, the signal transmission device illustrated in FIG. 2 can further support various specifications that adopt differential communication protocol. Any two pairs of differential pins in the plurality of positive differential pins for high-speed signal transmission and the plurality of negative differential pins (that is, the differential pins 111, 112, 121, 122, 131, 132, 141, 142, 171, 172, 181, 182, 191, 192, 101, and 102 and the differential high-speed pins 151, 152, 161, and 162) in the signal transmission device can transmit high-speed data transmission/reception signals complying with USB 2.0 or PCIe 1.0 and later specifications or other high-speed data transmission/reception signals adopting differential communication protocol.

In some embodiments, the signal transmission device illustrated in FIG. 1 to FIG. 2 can further support PCIe interface specifications. The positive differential low-speed pin 51, the negative differential low-speed pin 52, the first positive differential high-speed pin 151, the first negative differential high-speed pin 152, the second positive differential high-speed pin 161, and the second negative differential high-speed pin 162 are also adapted to PCIe interface specifications, and the positive differential low-speed pin 51 and the negative differential low-speed pin 52 can transmit a clock signal (which may include a positive clock content and a negative clock content) complying with the PCIe interface specifications.

In some embodiments, the signal transmission device can support a high definition multimedia interface (HDMI). As shown in FIG. 1 and FIG. 2, the above plurality of control signal pins may be plurality of SCL pins, a plurality of SDA pins, a hot plug detection pin 411, or a combination selected from the above items. The plurality of SCL pins are SCL/PCIE_WAKE_N pin 414 and REALONE_SCL pin 419 configured to transmit serial clock (SCL) signals. The plurality of SDA pins are SDA/PCIE_PERST_N pin 412 and REALONE_SDA pin 420 configured to transmit serial data (SDA) signals. The SCL pin and the SDA pin may be used for communication between a signal source device (such as a digital video disc, that is, a DVD) and a signal sink device (such as a television, that is, TV). The source device reads, through the SCL pin and the SDA pin, resolution supported by a playback device, so that the source device can display an image matching the resolution of the playback device. In addition, every four pairs of differential pins among the positive differential pins 111, 121, 131, 141, 171, 181, 191, and 101 and the negative differential pins 112, 122, 132, 142, 172, 182, 192, and 102 can transmit three pairs of transition minimized differential signaling (TMDS) and one pair of clock signals adapted for HDMI specifications to support transmission of HDMI signals.

In some embodiments, the plurality of control signal pins of the signal transmission device may be iRealOne_LINK pin 415, AUDIO-SYNC clock (AUDIO_SYNC_CLK) pin 413, a plurality of pins adapted for a serial peripheral interface (SPI), or a combination selected from the above items to transmit control signals related to voice and video between electronic devices. The plurality of pins adapted for the SPI include SPI_DI pin 416, SPI_CS pin 417, and SPI_WP_PWM pin 421, SPI_DO pin 423, SPI_HOLD_PWM pin 422, and SPI_CLK pin 418.

In some embodiments, one of the plurality of control signal pins of the signal transmission device may be a system main power enable pin 410. The system main power enable pin 410 transmits a control signal (or referred to as an enable signal) used to turn on or off an external device that supplies power. For example, the signal transmission device may be connected between a notebook computer and a tablet computer. The tablet computer may be considered as an external device of the notebook computer, and the tablet computer has a power supply function for supplying power to the notebook computer. The system main power enable pin 410 may transmit a control signal for turning on or off the above power supply function. In terms of configuration, the system main power enable pin 410 is located between the positive differential low-speed pin 51 and the negative differential low-speed pin 52 and the first positive differential high-speed pin 151, the first negative differential high-speed pin 152, the second positive differential high-speed pin 161, and the second negative differential high-speed pin 162, to isolate transmission of a low-speed data signal and transmission of a high-speed signal. In some embodiments, the above plurality of control signal pins are arranged along the same linear direction D1.

In some embodiments, the power signal pins 31 to 34 may be a plurality of low-voltage power pins and a plurality of high-voltage power pins. The power signal pins 31 and 32 are low-voltage power pins, that is, HV-POWER power pins. The power signal pins 31 and 32 supply HV-related low-voltage power signals. A voltage of the signal may be 12 volts (V). The power signal pins 33 and 34 are high-voltage power pins, that is, UHV-POWER power pins, and the power signal pins 33 and 34 supply UHV-related high-voltage power signals. A voltage of the signal may be 350 V. In some embodiments, a number of the plurality of low-voltage power pins and a number of the plurality of high-voltage power pins may be adjusted according to an actual conducted current of the signal transmission device and a differential signal transmission rate.

In some embodiments, as shown in FIG. 1 and FIG. 2, the plurality of ground pins of the signal transmission device can provide the grounding of power signal, that is, high-voltage ground pins 61 and 62 of the plurality of ground pins can be provided for grounding of the high-voltage power signal pins 33 and 34. The above power signal pins 33 and 34 and high-voltage ground pins 61 and 62 are arranged along the same linear direction D1. Furthermore, the signal transmission device further includes an insulating layer I. The insulating layer I is located between the power signal pins 33 and 34 and the high-voltage ground pins 61 and 62. In other words, the power signal pins 33 and 34, which are UHV-POWER pins, are located on one side of the insulating layer I, and the high-voltage ground pins 61 and 62 are located on the other side of the insulating layer I. Therefore, disposing the insulating layer I between the power signal pins 33 and 34 and the high-voltage ground pins 61 and 62 can prevent an electric arc or the signal transmission device from being damaged as a result of an excessive crossover voltage. In this embodiment, the insulating layer I is a pin structure.

In some embodiments, referring to FIG. 1 and FIG. 2, a metal isolation layer M is disposed on the signal transmission device for isolation between an electrical structure and a physical structure (between the plurality of pins of the signal transmission device). Specifically, as shown in FIG. 1 and FIG. 2, the power signal pins 31 and 32, the positive differential pins 111, 121, 131, 141, 171, 181, 191, and 101, the negative differential pins 112, 122, 132, 142, 172, 182, 192, and 102, and the ground pins 21, 22, 23, 24, 25, 26, 27, 28, and 29 are located on one side of the metal isolation layer M in the direction D2. The positive differential low-speed pin 51, the negative differential low-speed pin 52, the first positive differential high-speed pin 151, the first negative differential high-speed pin 152, the tenth ground pin 20, the second positive differential high-speed pin 161, the second negative differential high-speed pin 162, the plurality of control signal pins, the power signal pins 33 and 34, the high-voltage ground pin 61, the high-voltage ground pin 62, and the insulating layer I are located on the other side of the metal isolation layer M in the direction D2, and the direction D2 is perpendicular to the direction D1 (for example, the direction D2 may be a comparatively shorter direction of the signal transmission device). In other words, the positive differential pins 111, 121, 131, 141, 171, 181, 191, and 101 and the negative differential pin 112, 122, 132, 142, 172, 182, 192, and 102 are arranged side by side with the positive differential low-speed pin 51 and the negative differential low-speed pin 52 along the direction D2 by using the metal isolation layer M. The positive differential pins 111, 121, 131, 141, 171, 181, 191, and 101 and the negative differential pins 112, 122, 132, 142, 172, 182, 192, and 102 are arranged side by side with the first positive differential high-speed pin 151, the first negative differential high-speed pin 152, the second positive differential high-speed pin 161, and the second negative differential high-speed pin 162 along the direction D2 by using the metal isolation layer M. The positive differential pins 111, 121, 131, 141, 171, 181, 191, and 101 and the negative differential pins 112, 122, 132, 142, 172, 182, 192, and 102 are arranged side by side with the plurality of control signal pins along the direction D2 by using the metal isolation layer M. The power signal pins 31 and 32 are arranged side by side with the power signal pins 33 and 34 along the direction D2 by using the metal isolation layer M. In some embodiments, the metal isolation layer M may be an iron sheet, and can be connected to the ground voltage and used as a grounding plane. Based on this, the metal isolation layer M can prevent the pins on two sides from interfering with each other, and provide a good reference grounding plane to enhance signal quality and impedance matching characteristics. The two columns of pins side by side can also reduce the size of the signal transmission device and facilitate production.

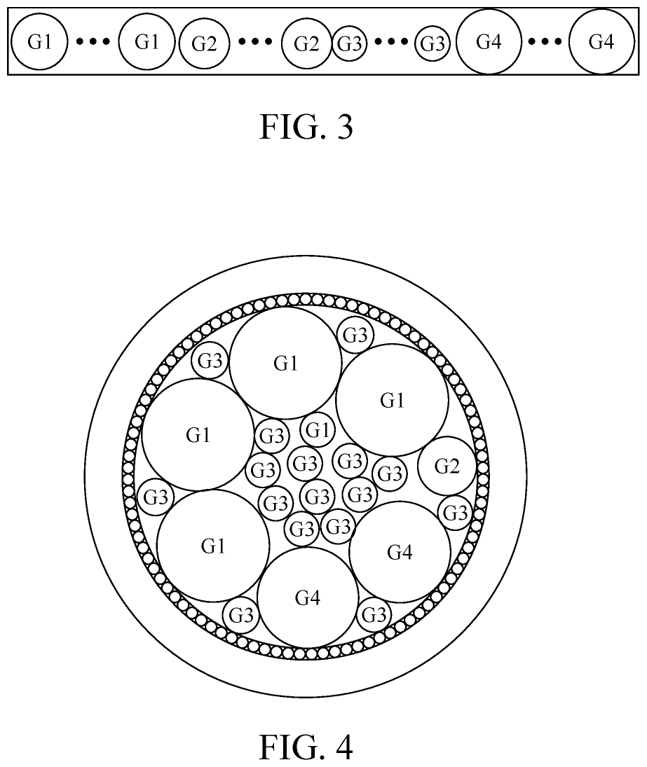

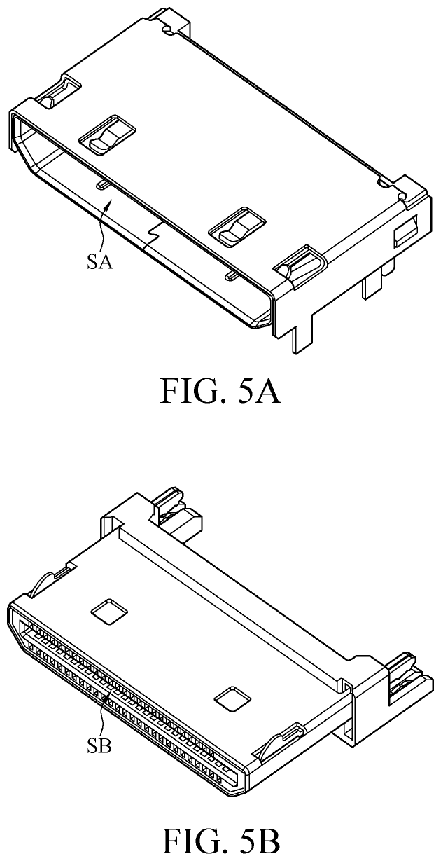

In some embodiments, referring to FIG. 1, FIG. 2, and FIG. 3, all of the pins of the signal transmission device may be formed by winding core wires, and may be arranged in the same straight line direction. For example, as shown in FIG. 3, a wire G1 may be a twisted-pair with a ground pin for shielding, a wire G2 may be a twisted-pair without ground pin for shielding, a wire G3 may be a thin single-core wire, and a wire G4 may be a thick single-core wire. All of the pins of the signal transmission device may be bundled into the wire G1, the wire G2, the wire G3, and the wire G4 and arranged in the same linear direction. In other embodiments, as shown in FIG. 4, the wires G1 to G4 may also be a bundle winding wrapped in a ring shape, that is, the wires G1, G2, G3, and G4 may not be arranged in the same linear direction.

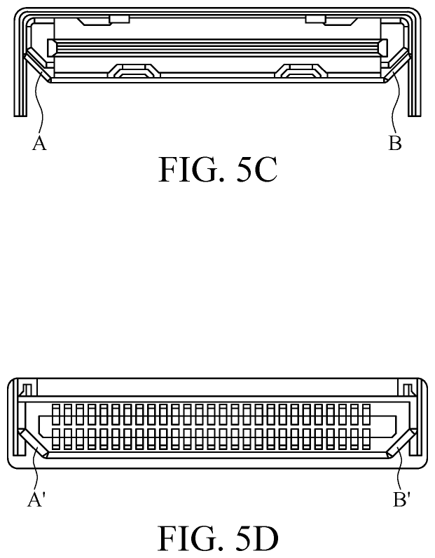

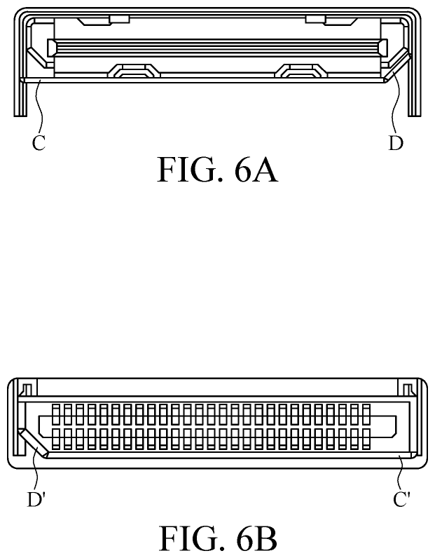

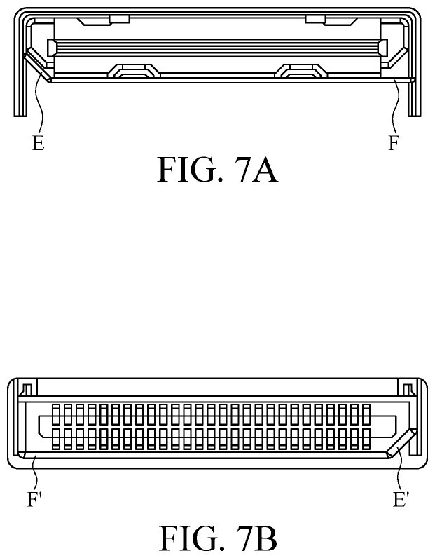

In some embodiments, the signal transmission device includes a housing. The signal transmission device may be designed as either a male connector or a female connector. The male connector and the female connector correspond to each other, and a signal transmission device as the male connector may be connected to a signal transmission device as the female connector. Referring to FIG. 5A to FIG. 5D, FIG. 5A and FIG. 5B respectively show embodiments of a female connector and a male connector, FIG. 5C is a schematic side view of a side SA of the signal transmission device in FIG. 5A, and FIG. 5D is a schematic side view of a side SB of the signal transmission device in FIG. 5B. As shown in FIG. 5C and FIG. 5D, an end A and an end A′ are designed as chamfer angles, and an end B and an end B′ are also designed as chamfer angles. Therefore, the two signal transmission devices, which are a female connector and a male connector, may be connected to each other according to the end A to the end A′ and the end B to the end B′. The chamfer angle may be used as a foolproof mechanism for avoiding a wrong connection between the male connector and the female connector. In other embodiments, the housing includes a chamfer angle and a right angle. The chamfer angle and the right angle are respectively located on two sides of the housing. Referring to FIG. 6A and FIG. 6B, FIG. 6A is another schematic diagram of the signal transmission device as a female connector, and FIG. 6B is another schematic diagram of the signal transmission device as a male connector. As shown in FIG. 6A and FIG. 6B, an end C and an end C′ are designed as right angles, and an end D and an end D′ are also designed as chamfer angles. Therefore, the two signal transmission devices, which are a female connector and a male connector, may be connected to each other according to the end C to the end C′ and the end D to the end D′. In some other embodiments, referring to FIG. 7A and FIG. 7B, FIG. 7A is another schematic diagram of the signal transmission device as a female connector, and FIG. 7B is another schematic diagram of the signal transmission device as a male connector. As shown in FIG. 7A and FIG. 7B, an end E and an end E′ are designed as chamfer angles, and an end F and an end F′ are designed as right angles. Therefore, the two signal transmission devices, which are a female connector and a male connector, may be connected to each other according to the end E to the end E′ and the end F to the end F′. Based on this, according to the different forms of chamfer angles of the connectors, the signal transmission device can provide a combination of signal transmission devices on different products and separate the connectors of the signal transmission device, to avoid possible misconnection between the male connector and the female connector.

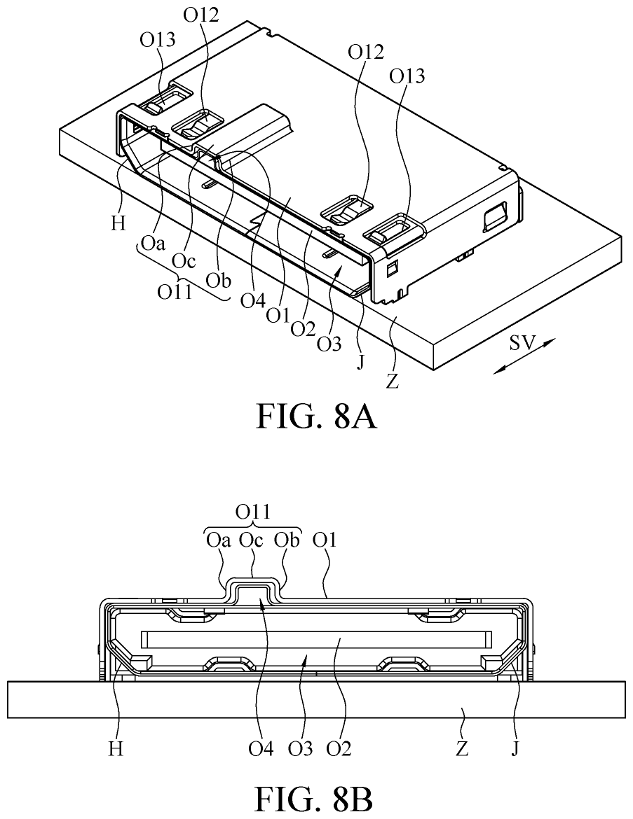

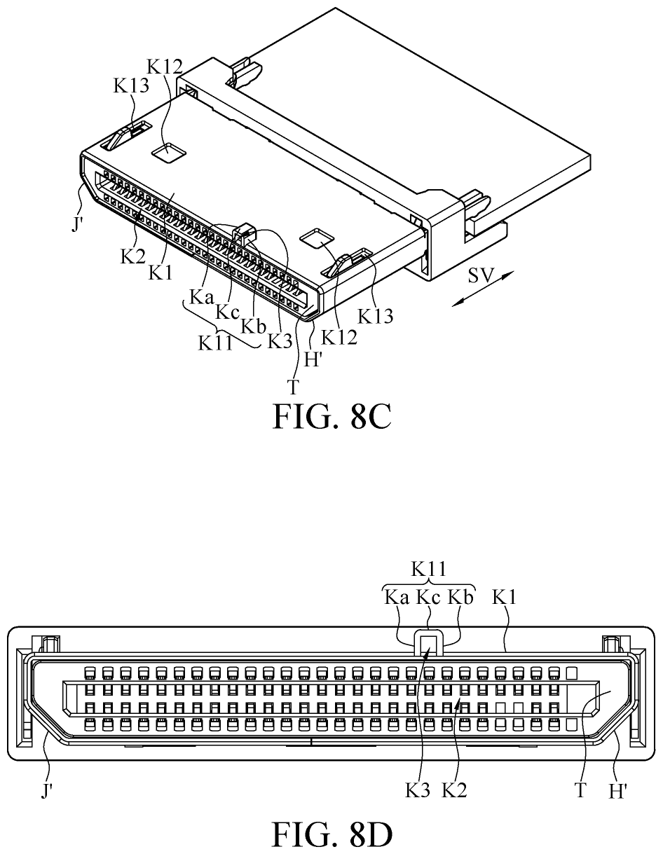

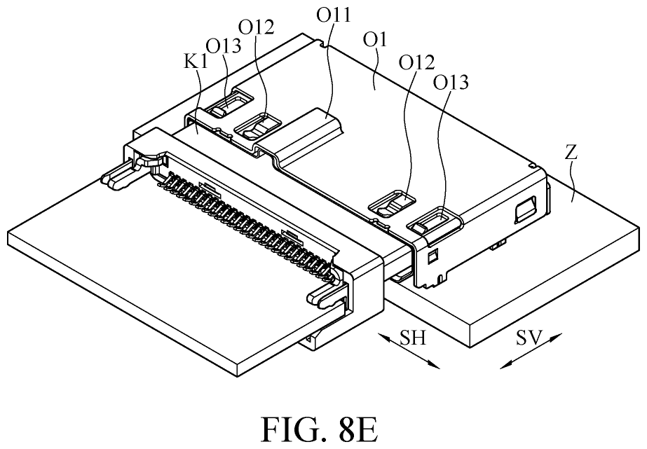

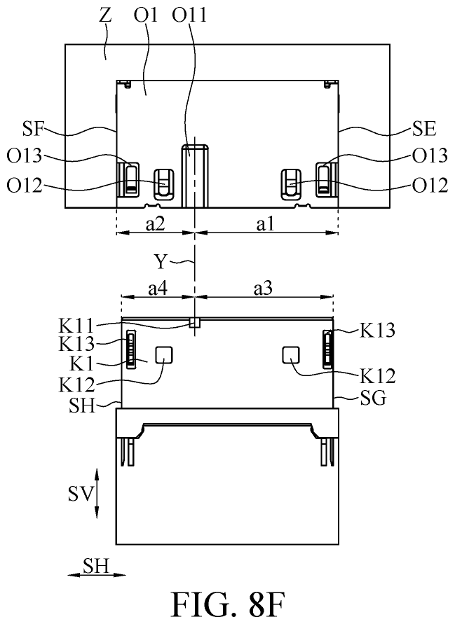

In some embodiments, referring to FIG. 8A to FIG. 8E, FIG. 8A and FIG. 8B are respectively a schematic appearance diagram and a schematic side view of a female connector, FIG. 8C and FIG. 8D are respectively a schematic appearance diagram and a schematic side view of a male connector, and FIG. 8E is a schematic appearance view of one embodiment showing that the female connector corresponding to FIG. 8A and FIG. 8B is mated with the male connector corresponding to FIG. 8C and FIG. 8D. As shown in FIG. 8A and FIG. 8B, the female connector includes a housing O1, a tongue portion O2, a receiving space O3 surrounded by the housing O1 and a plurality of pins. Moreover, the tongue portion O2 is disposed in the receiving space O3, and the tongue portion O2 is made of insulation material. In some embodiments, a metal isolation layer M is embedded in the tongue portion O2. Therefore, the tongue portion O2 not only can be provided for disposing pins, but also when the metal isolation layer M is connected to a fixed electrical potential (for example a grounding electrical potential), the metal isolation layer M can be provided for electrical isolation between signals at the upper surface of the tongue portion O2 and signals at the lower surface of the tongue portion O2 and can be provided for reference grounding of high-speed signals. The female connector is disposed on a substrate Z of a circuit board. The plurality of pins are the foregoing differential pins 111, 121, 131, 141, 171, 181, 191, 101, 51, 151, 161, 112, 122, 132, 142, 172, 182, 192, 102, 52, 152, and 162, ground pins 20-29 and 61-62, power signal pins 31-34, control signal pins 410-423. The pins and the insulating layer I are disposed on the tongue portion O2 and are respectively arranged on the upper surface and the lower surface of the tongue portion O2. For example, the power signal pins 31, 32, the positive differential pins, 111, 121, 131, 141, 171, 181, 191, and 101, the negative differential pins 112, 122, 132, 142, 172, 182, 192, and 102, and the ground pins 21-29 may be disposed on the upper surface of the tongue portion O2, and the positive differential low-speed pin 51, the negative differential low-speed pin 52, the first positive differential high-speed pin 151, the first negative differential high-speed pin 152, the tenth ground pin 20, the second positive differential high-speed pin 161, the second negative differential high-speed pin 162, the control signal pins, the power signal pins 33-34, the high-voltage ground pins 61-62, and the insulating layer I may be disposed on the lower surface of the tongue portion O2. Moreover, in one embodiment, the metal isolation layer M may be located at the tongue portion O2, and the metal isolation layer M is located between the upper surface and the lower surface of the tongue portion O2. In some other embodiments, the pins which are described to be disposed on the upper surface of the tongue portion O2 may be disposed on the lower surface of the tongue portion O2, and the pins which are described to be disposed on the lower surface of the tongue portion O2 may be disposed on the upper surface of the tongue portion O2.

In some embodiments, the housing O1 includes a protruding portion O11, and the protruding portion O11 is on a surface of the housing O1. For example, as shown in FIG. 8A and FIG. 8B, the protruding portion O11 may be on an upper surface of the housing O1. The protruding portion O11 includes a pair of side walls Oa, Ob and a top wall Oc. The side walls Oa, Ob are respectively connected to the housing O1, and the top wall Oc is connected between the side walls Oa, Ob. Accordingly, the side walls Oa, Ob and the top wall Oc together form an insertion space O4 of the female connector, and the insertion space O4 is in communication with the receiving space O3.

In some embodiments, the housing O1 includes a plurality of buckling members O12. The number of the buckling members O12 may be changed. The buckling members O12 are on at least one of the surfaces of the housing O1. For example, as shown in FIG. 8A and FIG. 8B, the number of the buckling members O12 is two, and the buckling members O12 are on the upper surface of the housing O1, that is, in this embodiment, the buckling members O12 and the protruding portion O11 are on the same surface. In some other embodiments, the housing O1 includes a plurality of buckling holes O13. The number of the buckling holes O13 may be changed as well. The buckling holes O13 are on at least one of the surfaces of the housing. For example, as shown in FIG. 8A and FIG. 8B, the number of the buckling holes O13 is two, and the buckling holes O13 are on the upper surface of the housing O1, that is, in this embodiment, the buckling holes O13, the buckling members O12, and the protruding portion O11 are on the same surface.

In some embodiments, as shown in FIG. 8C and FIG. 8D, the male connector includes a housing K1, an insulation member T in the housing K1, a receiving space K2 surrounded by the insulation member T, and a plurality of pins. The pins are disposed on the insulation member T. the pins are the foregoing differential pins 111, 121, 131, 141, 171, 181, 191, 101, 51, 151, 161, 112, 122, 132, 142, 172, 182, 192, 102, 52, 152, and 162, the ground pins 20-29 and 61-62, the power signal pins 31-34, and the control signal pins 410-423. The pins and the insulating layer I are disposed on an inner side of the housing K1 (namely, the inner side of the insulation member T), and are respectively arranged on the upper surface and the lower surface of the housing K1 (namely, the upper surface and the lower surface of the inner side of the insulation member T). For example, the power signal pins 31-32, the positive differential pins 111, 121, 131, 141, 171, 181, 191, and 101, the negative differential pins 112, 122, 132, 142, 172, 182, 192, and 102, and the ground pins 21-29 may be disposed on the upper surface of the inner side of the housing K1 (namely, the upper surface of the inner side of the insulation member T), and the positive differential low-speed pin 51, the negative differential low-speed pin 52, the first positive differential high-speed pin 151, the first negative differential high-speed pin 152, the tenth ground pin 20, the second positive differential high-speed pin 161, the second negative differential high-speed pin 162, the control signal pins, the power signal pins 33-34, the high-voltage ground pins 61-62, and the insulating layer I may be disposed on the lower surface of the inner side of the housing K1 (namely, the lower surface of the inner side of the insulation member T). In some other embodiments, the pins which are described to be disposed on the upper surface of the inner side of the housing K1 may be disposed on the lower surface of the inner side of the housing K1, and the pins which are described to be disposed on the lower surface of the inner side of the housing K1 may be disposed on the upper surface of the inner side of the housing K1.

In some embodiments, the housing K1 includes a protruding portion K11, and the protruding portion K11 is on a surface of the housing K1. For example, as shown in FIG. 8C and FIG. 8D, the protruding portion K11 may be on an upper surface of the housing K1. The protruding portion K11 includes a pair of side walls Ka, Kb and a top wall Kc. The side walls Ka, Kb are respectively connected to the housing K1, and the top wall Kc is connected between the side walls Ka, Kb. Accordingly, the side walls Ka, Kb and the top wall Kc together form an insertion space K4 of the male connector.

In some embodiments, the housing K1 includes a plurality of grooves K12, and the number of the grooves K12 corresponds to the number of the buckling members O12 of the female connector to be mated with the male connector. Moreover, positions of the grooves K12 on the housing K1 correspond to positions of the buckling members O12 on the housing O1. For example, as shown in FIG. 8C and FIG. 8D, the number of the grooves K12 is two, the grooves K12 on disposed on the upper surface of the housing K1 and the buckling members O12 are disposed on the upper surface of the housing O1, and the grooves K12 and the protruding portion K11 are on the same surface of the housing K1. In some other embodiments, the housing K1 comprises a plurality of buckling holes K13, and the number of the buckling holes K13 corresponds to the number of the buckling holes O13 of the female connector to be mated with the male connector. Moreover, positions of the buckling holes K13 on the housing K1 correspond to positions of the buckling holes O13 on the housing O1. As shown in FIG. 8C, the number of the buckling holes K13 is two, and the buckling holes K13 are on the upper surface of the housing K1, that is, in this embodiment, the buckling holes K13, the protruding portion K11, and the grooves K12 are on the same surface.

In some embodiments, referring to FIG. 8E, FIG. 8E illustrates a schematic view showing that the female connector in FIG. 8A and FIG. 8B is mated with the male connector in FIG. 8C and FIG. 8D, along the mating direction SV. When two signal transmission device are connected with each other, the housing O1 of the female connector surrounds the housing K1 of the male connector. In other words, in this embodiment, a plurality of surfaces of the housing O1 respectively cover a plurality of surfaces of the housing K1, and the housing K1 is at an inner side of the housing O1. Specifically, in this embodiment, the housing O1 is correspondingly connected to the housing K1, the protruding portion O11 is correspondingly connected to the protruding portion K11 and covers the protruding portion K11, and the tongue portion O2 of the female connector is inserted into the receiving space K2 of the male connector, so that the pins of the female connector and the pins of the male connector are electrically connected to each other. Moreover, the buckling members O12 are buckled with the grooves K12, and the buckling holes O13 are buckled with the buckling holes K13. Therefore, after the male connector and the female connector are mated with each other, the connectors cannot be detached from each other easily.

In some embodiments, referring to FIG. 8F, FIG. 8F illustrates a schematic top view showing that the male connector and the female connector are to be mated with each other. As shown in FIG. 8F, the protruding portion of the female connector is at a middle left position of the housing O1 (along the horizontal direction SH in FIG. 8F). Namely, in this embodiment, the distance between the central axis Y of the protruding portion O11 and the right inner surface SE of the housing O1 (hereinafter, the first distance) is length a1, the distance between the central axis Y of the protruding portion O11 and the left inner surface SF of the housing O1 (hereinafter, the second distance) is length a2, and the length a1 is larger than or equal to the length a2. Similarly, the protruding portion K11 of the male connector is at a middle left position of the housing K1 (along the horizontal direction SH in FIG. 8F). Namely, in this embodiment, the distance between the central axis Y of the protruding portion K11 and the right outer surface of the housing K1 (hereinafter, the third distance) is length a3, the distance between the central axis Y of the protruding portion K11 and the left outer surface SH (hereinafter, the fourth distance) is length a4, and the length a3 is larger than or equal to the length a4). The first distance corresponds to the third distance, and the second dstance corresponds to the fourth distance. Therefore, when the male connector is mated with the female connector, the housing O1 of the female connector surrounds the housing K1 of the male connector.

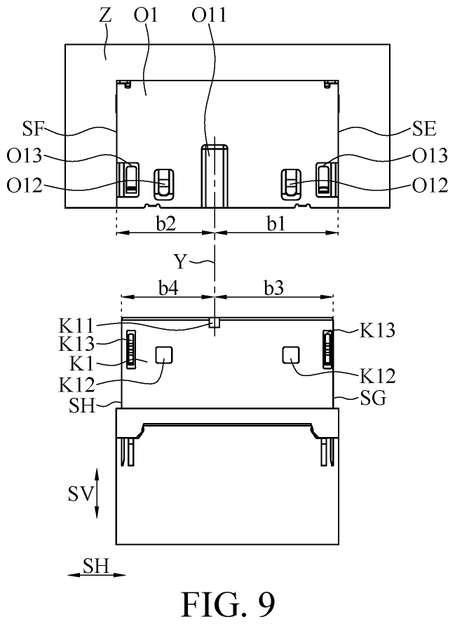

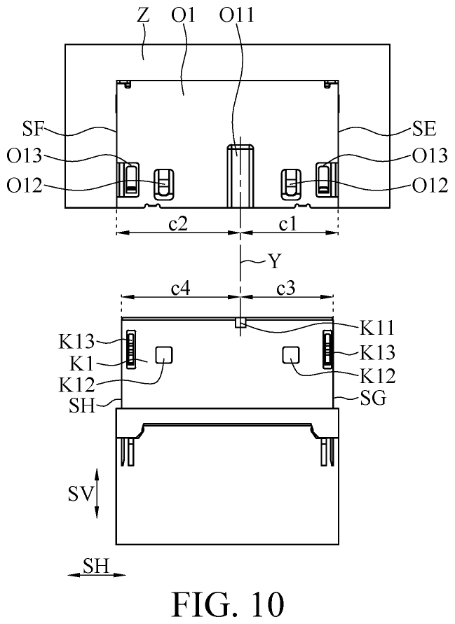

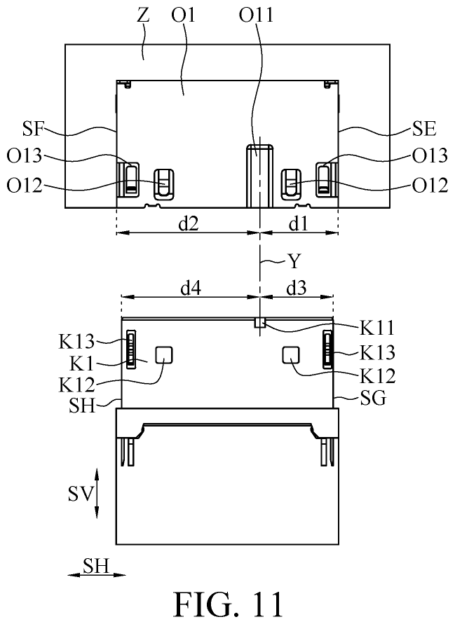

In some embodiments, the position of the protruding portion O11 on the housing O1 and the position of the protruding portion K11 on the housing K1 can be adjusted according to design preferences, as long as the protruding portion O11 of the housing O1 of the female connector can properly cover the protruding portion K11 of the housing K1 of the male connector when the female connector is mated with the male connector. In some embodiments, the position of the protruding portion O11 on the housing O1 and the position of the protruding portion K11 on the housing K1 may be arranged as shown in FIG. 9, FIG. 10, or FIG. 11. In FIG. 9, the length b1 of the first distance is larger than or equal to the length b2 of the second distance, and the length b3 of the third distance is larger than or equal to the length b4 of the fourth distance. Moreover, as compared with the embodiment shown in FIG. 8F, in FIG. 9, the length b1 is smaller than the length a1, the length b2 is larger than the length a2, the length b3 is smaller than the length a3, and the length b4 is larger than the length a4. In some other embodiments, as shown in FIG. 10, the protruding portion O11 may be at a middle right portion of the housing O1 (along the horizontal direction SH shown in FIG. 8F), the length c1 of the first distance is smaller than or equal to the length c2 of the second distance, and the length d3 of the third distance is smaller than or equal to the length c4 of the fourth distance. In some embodiments, as shown in FIG. 11, the length d1 of the first distance is smaller than or equal to the length d2 of the second distance, and the length d3 of the third distance is smaller than or equal to the length d4 of the fourth distance. Moreover, as compared with the embodiment shown in FIG. 10, in FIG. 11, the length d1 is smaller than the length c1, the length d2 is larger than the length c2, the length d3 is smaller than the length c3, and the length d4 is larger than the length c4. Accordingly, in this embodiment, by arranging the protruding portions O11 and K11 on specific positions of the housings O1 and K1, a specific male connector can be mated with a corresponding specific female connector; that is, the position of the protruding portion K11 on the housing K1 of the specific male connector corresponds to the position of the protruding portion O11 on the housing O1 of the specific female connector. Hence, the signal transmission devices on different products can be connected to each other. Moreover, with arranging the protruding portions O11 and K11 on different positions of the housings O1 and K1, the male connector for one product can be prevented from being mistakenly mated with the female connector for another different product.

In some embodiments, the housing of the signal transmission device may have the protruding portion and the chamfered angle at the same time. That is, in this embodiment, as shown in FIG. 8A to FIG. 8F, the end H and the end H′ may be configured as chamfered angles, and the end J and the end J′ may be configured as chamfered angles. Under this configuration, two signal transmission devices which are respectively served as a male connector and a corresponding female connector can be mate with each other, where the end H corresponds to the end H′, the end J corresponds to the end J′, the housing O1 corresponds to the housing K1, and the protruding portion O11 corresponds to the protruding portion K11. Accordingly, foolproof function can be provided for the signal transmission device.

In some embodiments, the number of the protruding portions O11 and K11 are not limited. The number of the protruding portions O11 and K11 may be plural, depending on design preferences. Moreover, the number of the protruding portions O11 corresponds to the number of the protruding portions K11, and each of the protruding portions O11 on the housing O1 corresponds to the corresponding protruding portion K11 on the housing K1.

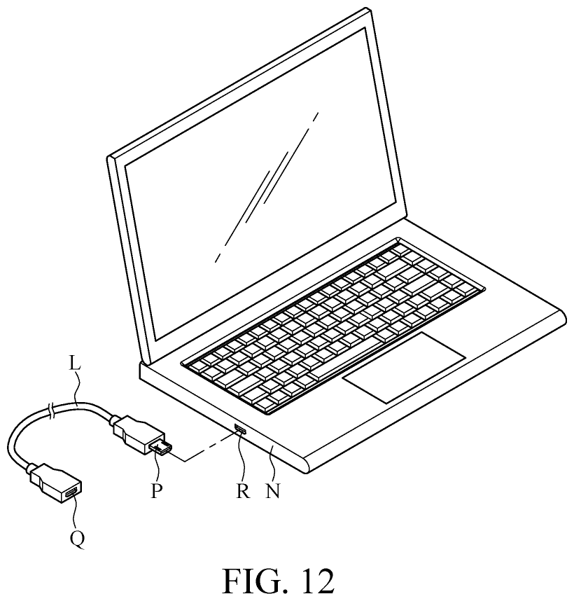

In some embodiments, referring to FIG. 12, FIG. 12 illustrates a transmission line and an electronic device N adapted for the transmission line. The transmission line includes signal transmission devices P and Q and a connection portion L. The signal transmission devices P and Q are disposed at two ends of the transmission line, and the connection portion L is connected between the signal transmission device P and the signal transmission device Q. The electronic device N includes a signal transmission device R corresponding to the signal transmission devices P and Q of the transmission line. Since the signal transmission devices P, Q, and R are respectively designed as either a male connector or a female connector, and the male connector may be connected to the female connector, the signal transmission device P or the signal transmission device Q may be connected to the signal transmission device R of the electronic device N. The electronic device N may be a notebook computer, a mobile phone, a tablet, a display, or other video/audio related devices. For example, when the signal transmission device P as a male connector is connected to the signal transmission device R as a female connector, and the signal transmission device Q as a female connector is connected to a signal transmission device of another electronic device as a male connector, the another electronic device can send a signal. The signal is transmitted from the signal transmission device Q of the transmission line, passes through the connection portion L and then the signal transmission device P and the signal transmission device R, and arrives at the electronic device N.

In some embodiments, the two signal transmission devices P and Q of the transmission line may be both the male connector or both the female connectors. In some embodiments, the two signal transmission devices P and Q of the transmission line may have same or different pin assignments.

In some embodiments, for example, the insulating layer I is not designed in the form of pin for totally 52 pins. As shown in FIG. 2 (from top to bottom and from left to right), the 1^{st} pin, the 4^{th} pin, the 7^{th} pin, the 10^{th} pin, the 13^{th} pin, the 16^{th} pin, the 19^{th} pin, the 22^{nd} pin, the 25^{th} pin, the 33^{rd} pin, the 49^{th} pin, and the 50^{th} pin are GND, the 2^{nd} pin, the 3^{rd} pin, the 5^{th} pin, the 6^{th} pin, the 8^{th} pin, the 9^{th} pin, the 11^{th} pin, the 12^{th} pin, the 14^{th} pin, the 15^{th} pin, the 17^{th} pin, the 18^{th} pin, the 20^{th} pin, the 21^{st} pin, the 23^{rd} pin, and the 24^{th} pin are respectively P3_RTK1_P, P3_RTK1_M, P3_RTK0_P, P3_RTK0_M, P2_RTK1_P, P2_RTK1_M, P2_RTK0_P, P2_RTK0_M, P1_RTK1_P, P1_RTK1_M, P1_RTK0_P, P1_RTK0_M, P0_RTK1_P, P0_RTK1_M, P0_RTK0_P, and P0_RTK0_M, the 26^{th} pin and the 27^{th} pin are HV_POWER, the 51^{st} pin and the 52^{nd} pin are UHV_POWER, the 28^{th} pin to the 32^{nd} pin and the 34^{th} pin to the 48^{th} pin are respectively USB_DM/REFCLK_M_PCIE, USB_DP/REFCLK_P_PCIE, SYSTEM_MAIN_POWER_EN, USB_SSRX_M/PCIE_HSIN, USB_SSRX_P/PCIE_HSIP, USB_SSTX_M/PCIE_HSON, USB_SSTX_P/PCIE_HSOP, HOT_PLUG_DETECT, SDA/PCIE_PERST_N, AUDIO_SYNC_CLK, SCL/PCIE_WAKE_N, iRealOne_LINK, SPI_DI, SPI_CS, SPI_CLK, REALONE_SCL, REALONE_SDA, SPI_WP_PWM, SPI_HOLD_PWM, and SPI_DO.

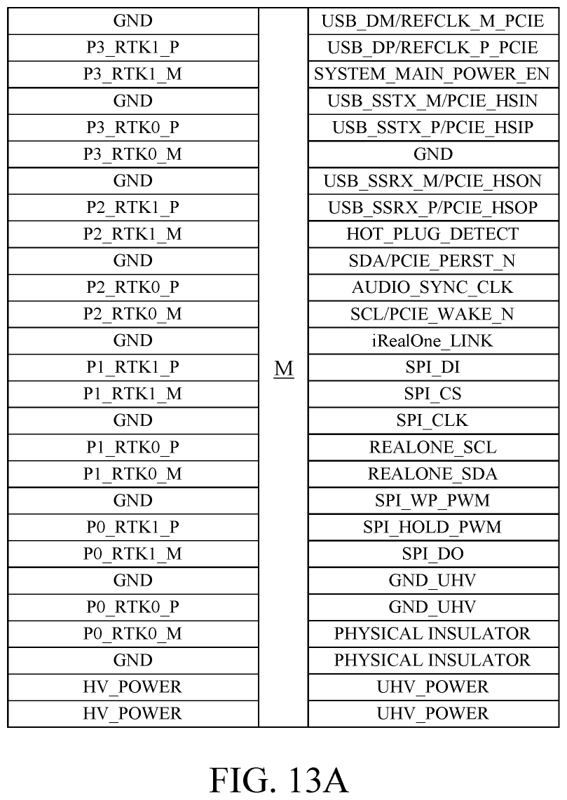

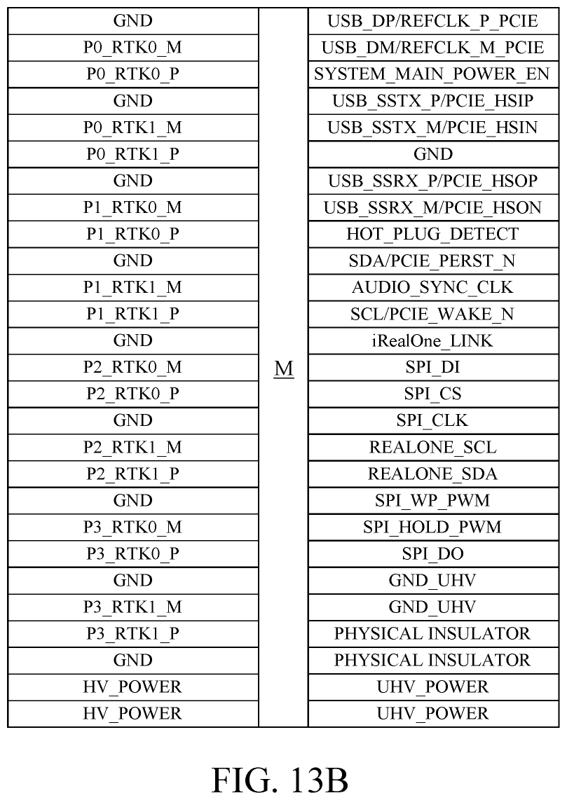

In some embodiments, for example, the insulating layer I is not designed in the form of pin, so that the total number of the pins is 52. As shown in FIG. 13A (from top to bottom and from left to right), the 1^{st} pin, the 4^{th} pin, the 7^{th} pin, the 10^{th} pin, the 13^{th} pin, the 16^{th} pin, the 19^{th} pin, the 22^{nd} pin, the 25^{th} pin, the 33^{rd} pin, the 49^{th} pin, and the 50^{th} pin are GND, the 2^{nd} pin, the 3^{rd} pin, the 5^{th} pin, the 6^{th} pin, the 8^{th} pin, the 9^{th} pin, the 11^{th} pin, the 12^{th} pin, the 14^{th} pin, the 15^{th} pin, the 17^{th} pin, the 18^{th} pin, the 20^{th} pin, the 21^{st} pin, the 23^{rd} pin, and the 24^{th} pin are respectively P3_RTK1_P, P3_RTK1_M, P3_RTK0_P, P3_RTK0_M, P2_RTK1_P, P2_RTK1_M, P2_RTK0_P, P2_RTK0_M, P1_RTK1_P, P1_RTK1_M, P1_RTK0_P, P1_RTK0_M, P0_RTK1_P, P0_RTK1_M, P0_RTK0_P, and P0_RTK0_M, the 26^{th} pin and the 27^{th} pin are HV_POWER, the 51^{st} pin and the 52^{nd} pin are UHV_POWER, the 28^{th} pin to the 32^{nd} pin and the 34^{th} pin to the 48^{th} pin are respectively USB_DM/REFCLK_M_PCIE, USB_DP/REFCLK_P_PCIE, SYSTEM_MAIN_POWER_EN, USB_SSRX_M/PCIE_HSIN, USB_SSRX_P/PCIE_HSIP, USB_SSTX_M/PCIE_HSON, USB_SSTX_P/PCIE_HSOP, HOT_PLUG_DETECT, SDA/PCIE_PERST_N, AUDIO_SYNC_CLK, SCL/PCIE_WAKE_N, iRealOne_LINK, SPI_DI, SPI_CS, SPI_CLK, REALONE_SCL, REALONE_SDA, SPI_WP_PWM, SPI_HOLD_PWM, and SPI_DO.

In some embodiments, for example, the insulating layer I is not designed in the form of pin, so that the total number of the pins is 52. As shown in FIG. 13B (from top to bottom and from left to right), the 1^{st} pin, the 4^{th} pin, the 7^{th} pin, the 10^{th} pin, the 13^{th} pin, the 16^{th} pin, the 19^{th} pin, the 22^{nd} pin, the 25^{th} pin, the 33^{rd} pin, the 49^{th} pin, and the 50^{th} pin are GND, the 2^{nd} pin, the 3^{rd} pin, the 5^{th} pin, the 6^{th} pin, the 8^{th} pin, the 9^{th} pin, the 11^{th} pin, the 12^{th} pin, the 14^{th} pin, the 15^{th} pin, the 17^{th} pin, the 18^{th} pin, the 20^{th} pin, the 21^{st} pin, the 23^{rd} pin, and the 24^{th} pin are respectively P0_RTK0_M, P0_RTK0_P, P0_RTK1_M, P0_RTK1_P, P1_RTK0_M, P1_RTK0_P, P1_RTK1_M, P1_RTK1_P, P2_RTK0_M, P2_RTK0_P, P2_RTK1_M, P2_RTK1_P, P3_RTK0_M, P3_RTK0_P, P3_RTK1_M, and P3_RTK1_P, the 26^{th} pin and the 27^{th} pin are HV_POWER, the 51^{st} pin and the 52^{nd} pin are UHV_POWER, the 28^{th} pin to the 32^{nd} pin and the 34^{th} pin to the 48^{th} pin are respectively USB_DP/REFCLK_P_PCIE, USB_DM/REFCLK_M_PCIE, SYSTEM_MAIN_POWER_EN, USB_SSTX_P/PCIE_HSIP, USB_SSTX_M/PCIE_HSIN, USB_SSRX_P/PCIE_HSOP, USB_SSRX_M/PCIE_HSON, HOT_PLUG_DETECT, SDA/PCIE_PERST_N, AUDIO_SYNC_CLK, SCL/PCIE_WAKE_N, iRealOne_LINK, SPI_DI, SPI_CS, SPI_CLK, REALONE_SCL, REALONE_SDA, SPI_WP_PWM, SPI_HOLD_PWM, and SPI_DO.

In some embodiments, the 1^{st} pin, the 2^{nd} pin, the 3^{rd} pin, the 4^{th} pin, the 5^{th} pin, the 6^{th} pin, the 7^{th} pin, the 8^{th} pin, the 9^{th} pin, the 10^{th} pin, the 11^{th} pin, the 12^{th} pin, and the 31^{st} pin to the 35^{th} pin may be unused according to the design in FIG. 2, that is, a total number of pins is 35. In other words, as shown in FIG. 1, the 1^{st} pin, the 4^{th} pin, the 7^{th} pin, the 10^{th} pin, the 13^{th} pin, the 32^{nd} pin, and the 33^{rd} pin are GND. The 2^{nd} pin, the 3^{rd} pin, the 5^{th} pin, the 6^{th} pin, the 8^{th} pin, the 9^{th} pin, the 11^{th} pin, and the 12^{th} pin are respectively P1_RTK1_P, P1_RTK1_M, P1_RTK0_P, P1_RTK0_M, P0_RTK1_P, P0_RTK1_M, P0_RTK0_P, and P0_RTK0_M. The 14^{th} pin and the 15^{th} pin are HV_POWER. The 34^{th} pin and the 35^{th} pin are UHV_POWER. The 16^{th} pin to the 31^{st} pin are respectively USB_DM/REFCLK_M_PCIE, USB_DP/REFCLK_P_PCIE, SYSTEM_MAIN_POWER_EN, HOT_PLUG_DETECT, SDA/PCIE_PERST_N, AUDIO_SYNC_CLK, SCL/PCIE_WAKE_N, iRealOne_LINK, SPI_DI, SPI_CS, SPI_CLK, REALONE_SCL, REALONE_SDA, SPI_WP_PWM, SPI_HOLD_PWM, and SPI_DO.

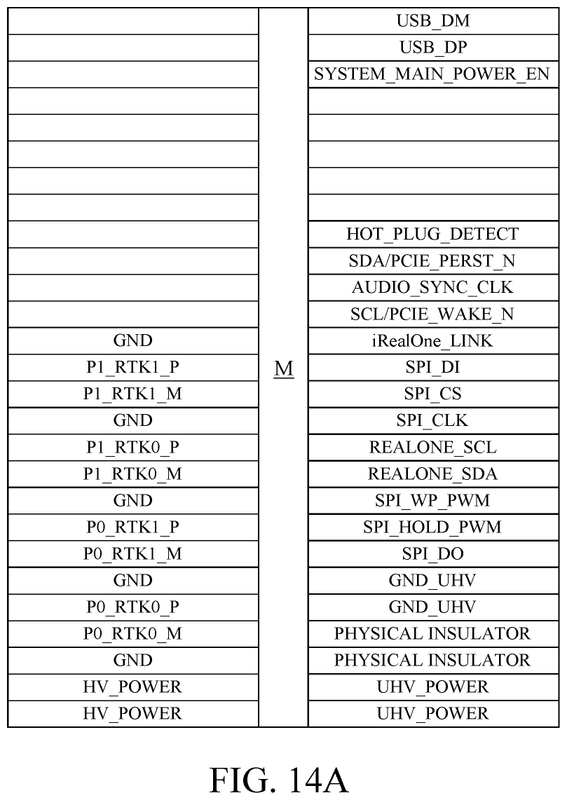

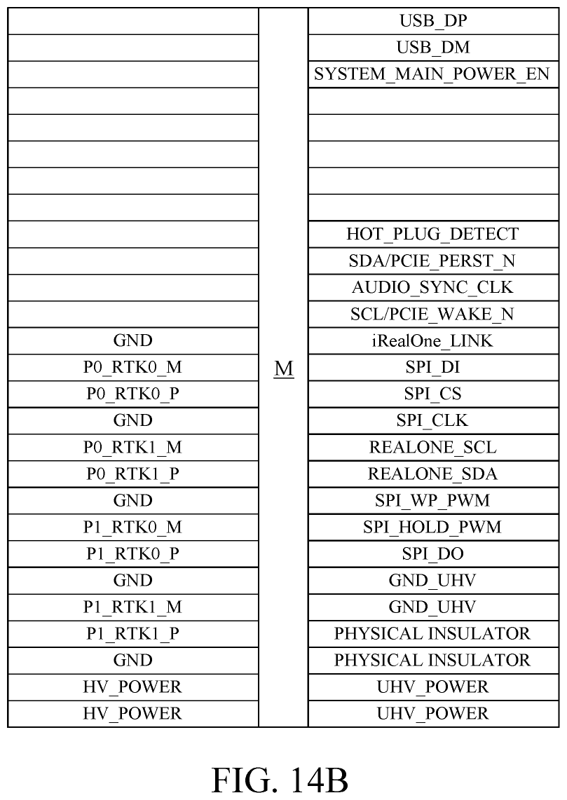

In some embodiments, the 1^{st} pin, the 2^{nd} pin, the 3^{rd} pin, the 4^{th} pin, the 5^{th} pin, the 6^{th} pin, the 7^{th} pin, the 8^{th} pin, the 9^{th} pin, the 10^{th} pin, the 11^{th} pin, the 12^{th} pin, and the 31^{st} pin to the 35^{th} pin may be unused (namely, these pins are NC (not-connected) pins) according to the design in FIG. 13A, that is, the total number of the pins is 35. In other words, in this embodiment, as shown in FIG. 14A, the 1^{st} pin, the 4^{th} pin, the 7^{th} pin, the 10^{th} pin, the 13^{th} pin, the 32^{nd} pin, and the 33^{rd} pin are GND. The 2^{nd} pin, the 3^{rd} pin, the 5^{th} pin, the 6^{th} pin, the 8^{th} pin, the 9^{th} pin, the 11^{th} pin, and the 12^{th} pin are respectively P1_RTK1_P, P1_RTK1_M, P1_RTK0_P, P1_RTK0_M, P0_RTK1_P, P0_RTK1_M, P0_RTK0_P, and P0_RTK0_M. The 14^{th} pin and the 15^{th} pin are HV_POWER. The 34^{th} pin and the 35^{th} pin are UHV_POWER. The 16^{th} pin to the 31^{st} pin are respectively USB_DM/REFCLK_M_PCIE, USB_DP/REFCLK_P_PCIE, SYSTEM_MAIN_POWER_EN, HOT_PLUG_DETECT, SDA/PCIE_PERST_N, AUDIO_SYNC_CLK, SCL/PCIE_WAKE_N, iRealOne_LINK, SPI_DI, SPI_CS, SPI_CLK, REALONE_SCL, REALONE_SDA SPI_WP_PWM SPI_HOLD_PWM, and SPI_DO.

In some embodiments, the 1^{st} pin, the 2^{nd} pin, the 3^{rd} pin, the 4^{th} pin, the 5^{th} pin, the 6^{th} pin, the 7^{th} pin, the 8^{th} pin, the 9^{th} pin, the 10^{th} pin, the 11^{th} pin, the 12^{th} pin, and the 31^{st} pin to the 35^{th} pin may be unused (namely, these pins are NC (not-connected) pins) according to the design in FIG. 13B, that is, the total number of the pins is 35. In other words, in this embodiment, as shown in FIG. 14B, the 1^{st} pin, the 4^{th} pin, the 7^{th} pin, the 10^{th} pin, the 13^{th} pin, the 32^{nd} pin, and the 33^{rd} pin are GND. The 2^{nd} pin, the 3^{rd} pin, the 5^{th} pin, the 6^{th} pin, the 8^{th} pin, the 9^{th} pin, the 11^{th} pin, and the 12^{th} pin are respectively P0_RTK0_M, P0_RTK0_P, P0_RTK1_M, P0_RTK1_P, P1_RTK0_M, P1_RTK0_P, P1_RTK1_M, and P1_RTK1_P. The 14^{th} pin and the 15^{th} pin are HV_POWER. The 34^{th} pin and the 35^{th} pin are UHV_POWER. The 16^{th} pin to the 31^{st} pin are respectively USB_DP/REFCLK_P_PCIE, USB_DM/REFCLK_M_PCIE, SYSTEM_MAIN_POWER_EN, HOT_PLUG_DETECT, SDA/PCIE_PERST_N, AUDIO_SYNC_CLK, SCL/PCIE_WAKE_N, iRealOne_LINK, SPI_DI, SPI_CS, SPI_CLK, REALONE_SCL REALONE_SDA SPI_WP_PWM SPI_HOLD_PWM, and SPI_DO.

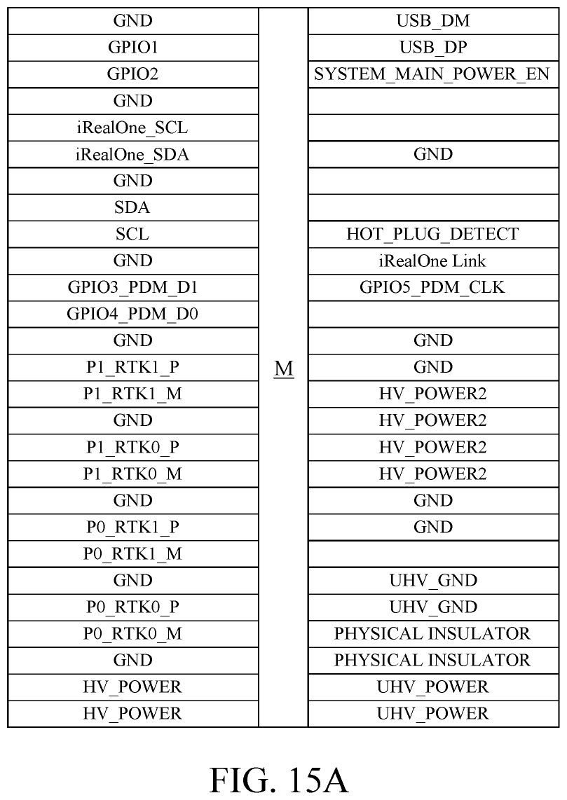

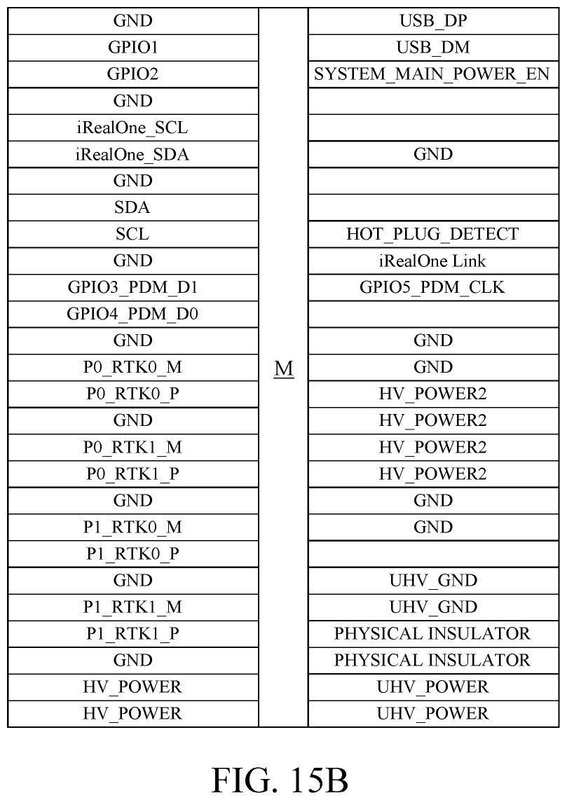

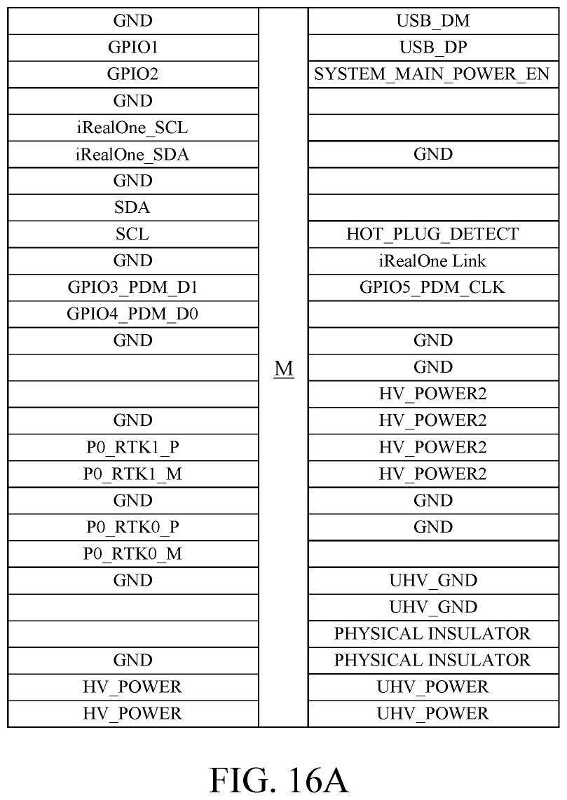

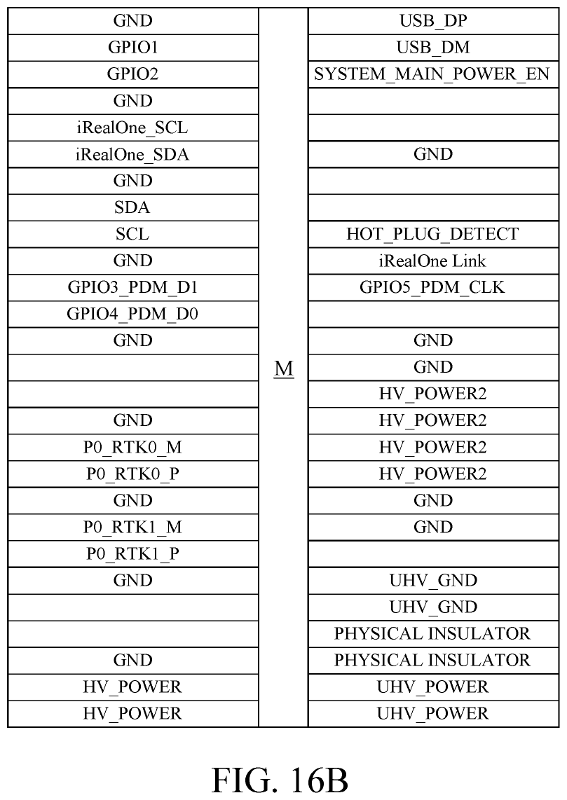

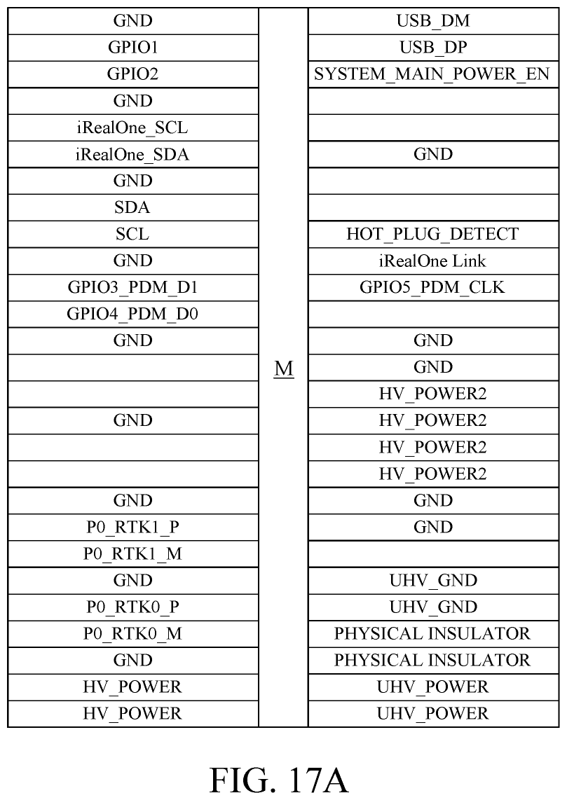

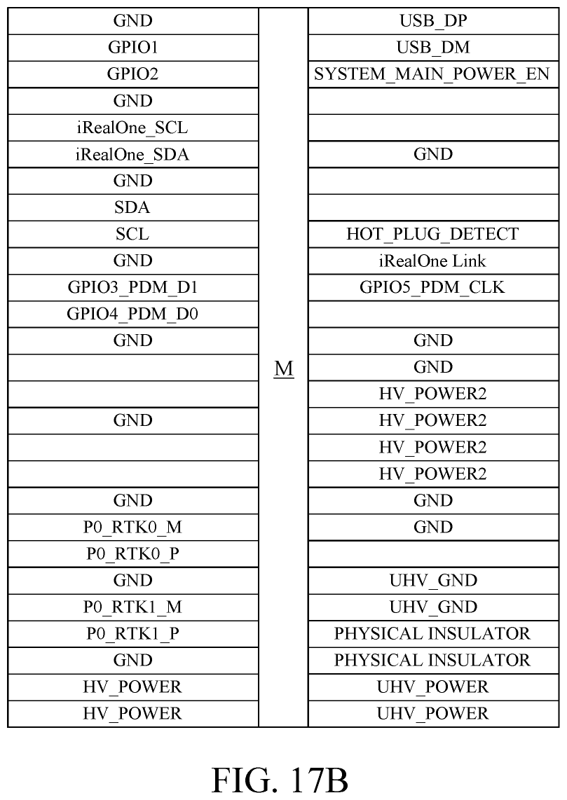

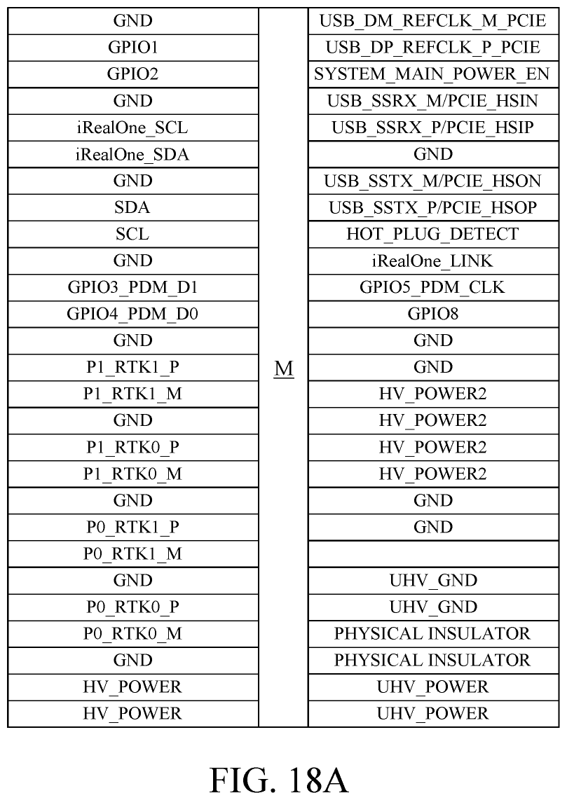

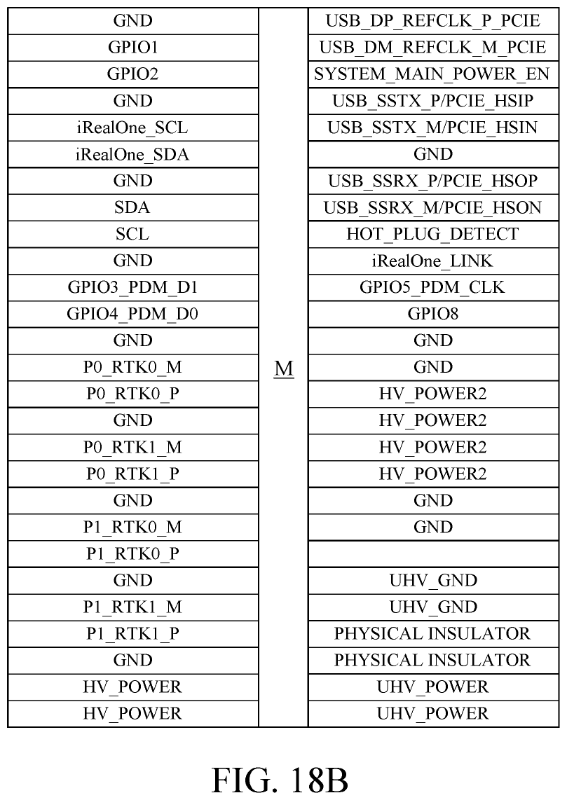

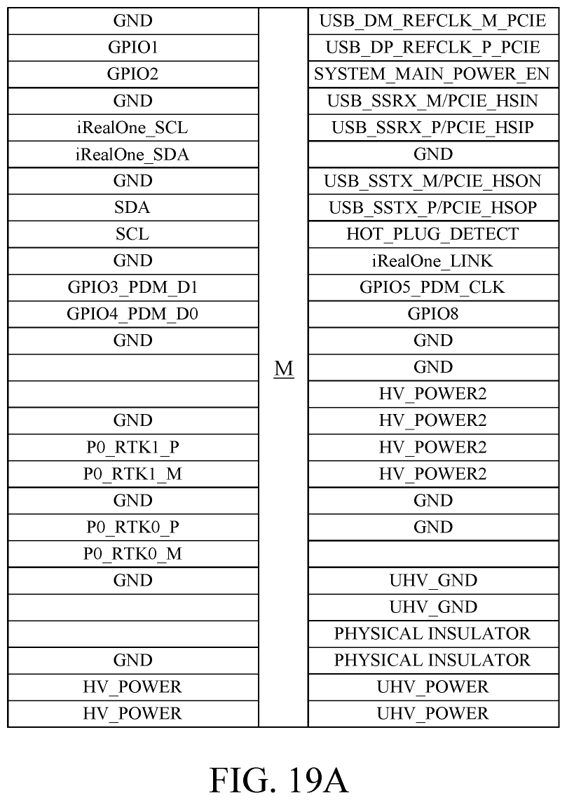

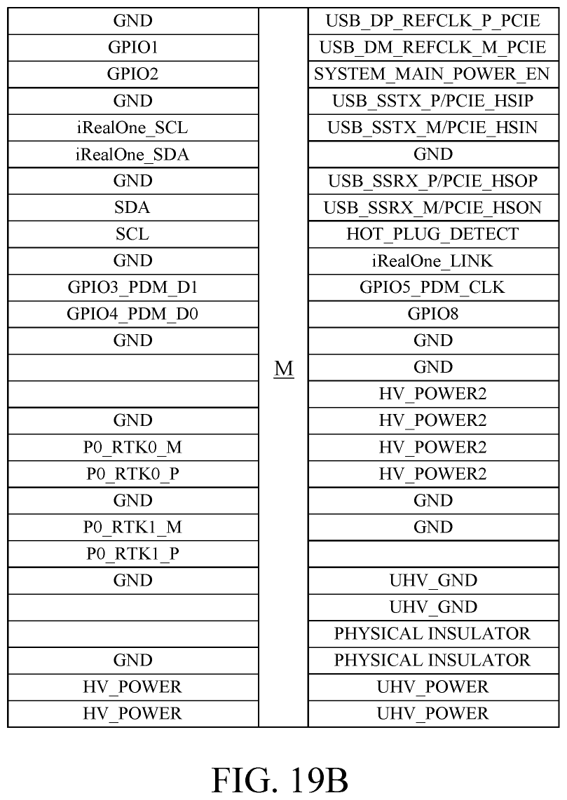

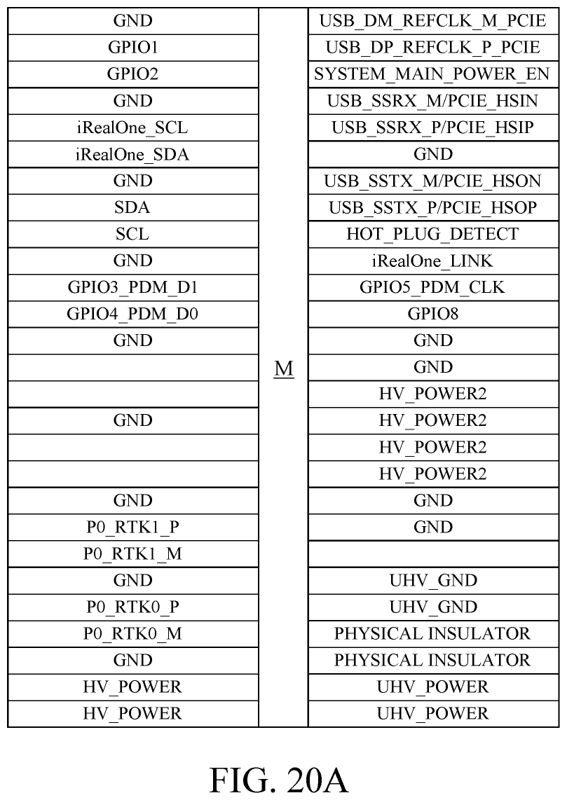

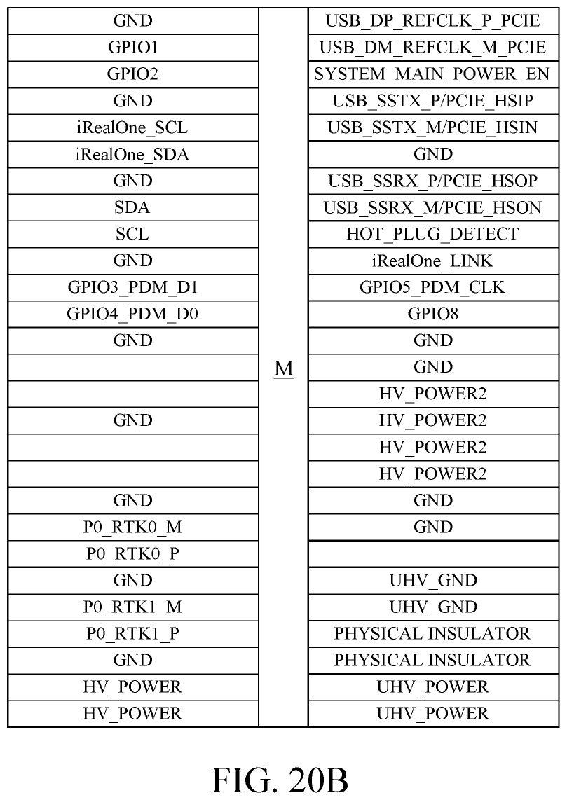

FIG. 15A to FIG. 20B respectively illustrate schematic views of embodiments of the signal transmission device of the disclosure. The signal transmission devices in FIG. 15A and FIG. 15B may be respectively applied to the two signal transmission devices P and Q of the transmission line shown in FIG. 12. The signal transmission devices in FIG. 16A and FIG. 16B may be respectively applied to the two signal transmission devices P and Q of the transmission line shown in FIG. 12. The signal transmission devices in FIG. 17A and FIG. 17B may be respectively applied to the two signal transmission devices P and Q of the transmission line shown in FIG. 12. The signal transmission devices in FIG. 18A and FIG. 18B may be respectively applied to the two signal transmission devices P and Q of the transmission line shown in FIG. 12. The signal transmission devices in FIG. 19A and FIG. 19B may be respectively applied to the two signal transmission devices P and Q of the transmission line shown in FIG. 12. The signal transmission devices in FIG. 20A and FIG. 20B may be respectively applied to the two signal transmission devices P and Q of the transmission line shown in FIG. 12.

The pins in FIG. 1 and FIG. 14A to FIG. 20B that do not have pin assignments (the first 12 pins (the 1^{st} pin to the 12^{th} pin) at the left right portion of FIG. 1 and the fourth pin to the eighth pin (the 31^{st} pin to the 35^{th} pin) at the right portion of FIG. 1) are NC (not-connected) pins, but embodiments are not limited thereto. In some embodiments, without affecting the electrical property of the device, the NC pins may be electrically connected to the power terminal or the ground terminal, may be served as the pins for general purpose input/output, or may be served as pins for other purposes.

In FIG. 15A, the pins of the signal transmission device from the 1^{st} pin to the 54^{th} pin (the pins are sequentially numbered from the upper left portion to the bottom, and then from the upper right portion to the bottom) are respectively GND, GPIO1, GPIO2, GND, iRealOne_SCL, iRealOne_SDA, GND, SDA, SCL, GND, GPIO3/PDM_D1, GPIO4/PDM_D0, GND, P1_RTK1_P, P1_RTK1_M, GND, P1_RTK0_P, P1_RTK0_M, GND, P0_RTK1_P, P0_RTK1_M, GND, P0_RTK0_P, P0_RTK0_M, GND, HV_POWER, HV_POWER, USB_DM, USB_DP, SYSTEM_MAIN_POWER_EN, NC, NC, GND, NC, NC, HOT_PLUG_DETECT, iRealOne_LINK, GPIO5_PDM_CLK, NC, GND, GND, HV_POWER2, HV_POWER2, HV_POWER2, HV_POWER2, GND, GND, NC, UHV_GND, UHV_GND, PHYSICAL INSULATOR, PHYSICAL INSULATOR, UHV_POWER, and UHV_POWER. “NC” represents not-connected. “PHYSICAL INSULATOR” represents physically insulation, which is provided for preventing the flash arc or electrical coupling caused by the excessive cross voltage between the power signal pin and the ground pin. “GND” represents grounding. “POWER” represents the power. “PDM” represents the pulse density modulation. “SCL/SDA” represents a set of an I2C interface. “iRealOne_SCL” and “iRealOne_SDA” respectively represent a set of a specific I2C interface for the signal transmission device. “GPIO” represents the general purpose input/output port. “P0_TRK0_M” and “P0_TRK0_P” represent the same set of differential pins of the signal transmission device. “HV_POWER” and “HV_POWER2” represent two sets of high voltage powers transmitted through the signal transmission device. “UHV_POWER” and “UHV_GND” respectively represent an ultra-high voltage power transmitted through the signal transmission device and a corresponding ground signal. “SYSTEM_MAIN_POWER_EN” represents the signal for turning the main power on or off “iRealOne_LINK” represents a signal for transmitting certain packets of the signal transmission device.

In FIG. 15B, the pins of the signal transmission device from the 1^{st} pin to the 54^{th} pin are respectively GND, GPIO1, GPIO2, GND, iRealOne_SCL, iRealOne_SDA, GND, SDA, SCL, GND, GPIO3/PDM_D1, GPIO4/PDM_D0, GND, P0_RTK0_M, P0_RTK0_P, GND, P0_RTK1_M, P0_RTK1_P, GND, P1_RTK0_M, P1_RTK0_P, GND, P1_RTK1_M, P1_RTK1_P, GND, HV_POWER, HV_POWER, USB_DP, USB_DM, SYSTEM_MAIN_POWER_EN, NC, NC, GND, NC, NC, HOT_PLUG_DETECT, iRealOne_LINK, GPIO5_PDM_CLK, NC, GND, GND, HV_POWER2, HV_POWER2, HV_POWER2, HV_POWER2, GND, GND, NC, UHV_GND, UHV_GND, PHYSICAL INSULATOR, PHYSICAL INSULATOR, UHV_POWER, and UHV_POWER.

In FIG. 16A, the pins of the signal transmission device from the 1^{st} pin to the 54^{th} pin are respectively GND, GPIO1, GPIO2, GND, iRealOne_SCL, iRealOne_SDA, GND, SDA, SCL, GND, GPIO3/PDM_D1, GPIO4/PDM_D0, GND, NC, NC, GND, P0_RTK1_P, P0_RTK1_M, GND, P0_RTK0_P, P0_RTK0_M, GND, NC, NC, GND, HV_POWER, HV_POWER, USB_DM, USB_DP, SYSTEM_MAIN_POWER_EN, NC, NC, GND, NC, NC, HOT_PLUG_DETECT, iRealOne_LINK, GPIO5_PDM_CLK, NC, GND, GND, HV_POWER2, HV_POWER2, HV_POWER2, HV_POWER2, GND, GND, NC, UHV_GND, UHV_GND, PHYSICAL INSULATOR, PHYSICAL INSULATOR, UHV_POWER, and UHV_POWER.

In FIG. 16B, the pins of the signal transmission device from the 1^{st} pin to the 54^{th} pin are respectively GND, GPIO1, GPIO2, GND, iRealOne_SCL, iRealOne_SDA, GND, SDA, SCL, GND, GPIO3/PDM_D1, GPIO4/PDM_D0, GND, NC, NC, GND, P0_RTK0_M, P0_RTK0_P, GND, P0_RTK1_M, P0_RTK1_P, GND, NC, NC, GND, HV_POWER, HV_POWER, USB_DP, USB_DM, SYSTEM_MAIN_POWER_EN, NC, NC, GND, NC, NC, HOT_PLUG_DETECT, iRealOne_LINK, GPIO5_PDM_CLK, NC, GND, GND, HV_POWER2, HV_POWER2, HV_POWER2, HV_POWER2, GND, GND, NC, UHV_GND, UHV_GND, PHYSICAL INSULATOR, PHYSICAL INSULATOR, UHV_POWER, and UHV_POWER.

In FIG. 17A, the pins of the signal transmission device from the 1^{st} pin to the 54^{th} pin are respectively GND, GPIO1, GPIO2, GND, iRealOne_SCL, iRealOne_SDA, GND, SDA, SCL, GND, GPIO3/PDM_D1, GPIO4/PDM_D0, GND, NC, NC, GND, NC, NC, GND, P0_RTK1_P, P0_RTK1_M, GND, P0_RTK0_P, P0_RTK0_M, GND, HV_POWER, HV_POWER, USB_DM, USB_DP, SYSTEM_MAIN_POWER_EN, NC, NC, GND, NC, NC, HOT_PLUG_DETECT, iRealOne_LINK, GPIO5_PDM_CLK, NC, GND, GND, HV_POWER2, HV_POWER2, HV_POWER2, HV_POWER2, GND, GND, NC, UHV_GND, UHV_GND, PHYSICAL INSULATOR, PHYSICAL INSULATOR, UHV_POWER, and UHV_POWER.

In FIG. 17B, the pins of the signal transmission device from the 1^{st} pin to the 54^{th} pin are respectively GND, GPIO1, GPIO2, GND, iRealOne_SCL, iRealOne_SDA, GND, SDA, SCL, GND, GPIO3/PDM_D1, GPIO4/PDM_D0, GND, NC, NC, GND, NC, NC, GND, P0_RTK0_M, P0_RTK0_P, GND, P0_RTK1_M, P0_RTK1_P, GND, HV_POWER, HV_POWER, USB_DP, USB_DM, SYSTEM_MAIN_POWER_EN, NC, NC, GND, NC, NC, HOT_PLUG_DETECT, iRealOne_LINK, GPIO5_PDM_CLK, NC, GND, GND, HV_POWER2, HV_POWER2, HV_POWER2, HV_POWER2, GND, GND, NC, UHV_GND, UHV_GND, PHYSICAL INSULATOR, PHYSICAL INSULATOR, UHV_POWER, and UHV_POWER.

In FIG. 18A, the pins of the signal transmission device from the 1^{st} pin to the 54^{th} pin are respectively GND, GPIO1, GPIO2, GND, iRealOne_SCL, iRealOne_SDA, GND, SDA, SCL, GND, GPIO3/PDM_D1, GPIO4/PDM_D0, GND, P1_RTK1_P, P1_RTK1_M, GND, P1_RTK0_P, P1_RTK0_M, GND, P0_RTK1_P, P0_RTK1_M, GND, P0_RTK0_P, P0_RTK0_M, GND, HV_POWER, HV_POWER, USB_DM/REFCLK_M_PCIE, USB_DP/REFCLK_P_PCIE, SYSTEM_MAIN_POWER_EN, USB_SSRX_M/PCIE_HSIN, USB_SSRX_P/PCIE_HSIP, GND, USB_SSTX_M/PCIE_HSON, USB_SSTX_P/PCIE_HSOP, HOT_PLUG_DETECT, iRealOne_LINK, GPIO5_PDM_CLK, GPIO8, GND, GND, HV_POWER2, HV_POWER2, HV_POWER2, HV_POWER2, GND, GND, NC, UHV_GND, UHV_GND, PHYSICAL INSULATOR, PHYSICAL INSULATOR, UHV_POWER, and UHV_POWER.

In FIG. 18B, the pins of the signal transmission device from the 1^{st} pin to the 54^{th} pin are respectively GND, GPIO1, GPIO2, GND, iRealOne_SCL, iRealOne_SDA, GND, SDA, SCL, GND, GPIO3/PDM_D1, GPIO4/PDM_D0, GND, P0_RTK0_M, P0_RTK0_P, GND, P0_RTK1_M, P0_RTK1_P, GND, P1_RTK0_M, P1_RTK0_P, GND, P1_RTK1_M, P1_RTK1_P, GND, HV_POWER, HV_POWER, USB_DP/REFCLK_P_PCIE, USB_DM/REFCLK_M_PCIE, SYSTEM_MAIN_POWER_EN, USB_SSTX_M/PCIE_HSIP, USB_SSTX_M/PCIE_HSIN, GND, USB_SSRX_P/PCIE_HSOP, USB_SSRX_M/PCIE_HSON, HOT_PLUG_DETECT, iRealOne_LINK, GPIO5_PDM_CLK, GPIO8, GND, GND, HV_POWER2, HV_POWER2, HV_POWER2, HV_POWER2, GND, GND, NC, UHV_GND, UHV_GND, PHYSICAL INSULATOR, PHYSICAL INSULATOR, UHV_POWER, and UHV_POWER.

In FIG. 19A, the pins of the signal transmission device from the 1^{st} pin to the 54^{th} pin are respectively GND, GPIO1, GPIO2, GND, iRealOne_SCL, iRealOne_SDA, GND, SDA, SCL, GND, GPIO3/PDM_D1, GPIO4/PDM_D0, GND, NC, NC, GND, P0_RTK1_P, P0_RTK1_M, GND, P0_RTK0_P, P0_RTK0_M, GND, NC, NC, GND, HV_POWER, HV_POWER, USB_DM/REFCLK_M_PCIE, USB_DP/REFCLK_P_PCIE, SYSTEM_MAIN_POWER_EN, USB_SSRX_M/PCIE_HSIN, USB_SSRX_P/PCIE_HSIP, GND, USB_SSTX_M/PCIE_HSON, USB_SSTX_P/PCIE_HSOP, HOT_PLUG_DETECT, iRealOne_LINK, GPIO5_PDM_CLK, GPIO8, GND, GND, HV_POWER2, HV_POWER2, HV_POWER2, HV_POWER2, GND, GND, NC, UHV_GND, UHV_GND, PHYSICAL INSULATOR, PHYSICAL INSULATOR, UHV_POWER, and UHV_POWER.

In FIG. 19B, the pins of the signal transmission device from the 1^{st} pin to the 54^{th} pin are respectively GND, GPIO1, GPIO2, GND, iRealOne_SCL, iRealOne_SDA, GND, SDA, SCL, GND, GPIO3/PDM_D1, GPIO4/PDM_D0, GND, NC, NC, GND, P0_RTK0_M, P0_RTK0_P, GND, P0_RTK1_M, P0_RTK1_P, GND, NC, NC, GND, HV_POWER, HV_POWER, USB_DP/REFCLK_P_PCIE, USB_DM/REFCLK_M_PCIE, SYSTEM_MAIN_POWER_EN, USB_SSTX_P/PCIE_HSIP, USB_SSTX_M/PCIE_HSIN, GND, USB_SSRX_P/PCIE_HSOP, USB_SSRX_M/PCIE_HSON, HOT_PLUG_DETECT, iRealOne_LINK, GPIO5_PDM_CLK, GPIO8, GND, GND, HV_POWER2, HV_POWER2, HV_POWER2, HV_POWER2, GND, GND, NC, UHV_GND, UHV_GND, PHYSICAL INSULATOR, PHYSICAL INSULATOR, UHV_POWER, and UHV_POWER.

In FIG. 20A, the pins of the signal transmission device from the 1^{st} pin to the 54^{th} pin are respectively GND, GPIO1, GPIO2, GND, iRealOne_SCL, iRealOne_SDA, GND, SDA, SCL, GND, GPIO3/PDM_D1, GPIO4/PDM_D0, GND, NC, NC, GND, NC, NC, GND, P0_RTK1_P, P0_RTK1_M, GND, P0_RTK0_P, P0_RTK0_M, GND, HV_POWER, HV_POWER, USB_DM/REFCLK_M_PCIE, USB_DP/REFCLK_P_PCIE, SYSTEM_MAIN_POWER_EN, USB_SSRX_M/PCIE_HSIN, USB_SSRX_P/PCIE_HSIP, GND, USB_SSTX_M/PCIE_HSON, USB_SSTX_P/PCIE_HSOP, HOT_PLUG_DETECT, iRealOne_LINK, GPIO5_PDM_CLK, GPIO8, GND, GND, HV_POWER2, HV_POWER2, HV_POWER2, HV_POWER2, GND, GND, NC, UHV_GND, UHV_GND, PHYSICAL INSULATOR, PHYSICAL INSULATOR, UHV_POWER, and UHV_POWER.

In FIG. 20B, the pins of the signal transmission device from the 1^{st} pin to the 54^{th} pin are respectively GND, GPIO1, GPIO2, GND, iRealOne_SCL, iRealOne_SDA, GND, SDA, SCL, GND, GPIO3/PDM_D1, GPIO4/PDM_D0, GND, NC, NC, GND, NC, NC, GND, P0_RTK0_M, P0_RTK0_P, GND, P0_RTK1_M, P0_RTK1_P, GND, HV_POWER, HV_POWER, USB_DM/REFCLK_M_PCIE, USB_DP/REFCLK_P_PCIE, SYSTEM_MAIN_POWER_EN, USB_SSTX_P/PCIE_HSIP, USB_SSTX_M/PCIE_HSIN, GND, USB_SSRX_P/PCIE_HSOP, USB_SSRX_M/PCIE_HSON, HOT_PLUG_DETECT, iRealOne_LINK, GPIO5_PDM_CLK, GPIO8, GND, GND, HV_POWER2, HV_POWER2, HV_POWER2, HV_POWER2, GND, GND, NC, UHV_GND, UHV_GND, PHYSICAL INSULATOR, PHYSICAL INSULATOR, UHV_POWER, and UHV_POWER.

In some embodiments, a number of the above core wires may be adjusted according to different applications and embodiments. If there are 52 pins and all of the pins are used, the signal transmission device may be formed by winding 50 core wires. If there are 52 pins and 35 of the pins are used, the signal transmission device may be formed by winding 33 core wires. Users may choose different winding combinations of differential pins and control signals according to specifications required to be supported, to implement data and power signal transmission.

In summary, according to an embodiment of the signal transmission device of the disclosure, a same pair of differential signal pins is disposed between the two ground pins, so that the crosstalk between two adjacent pairs of differential signal pins can be avoided and better impedance matching characteristics can be obtained. Furthermore, a ground pin is disposed at an extreme edge of a pin accommodation space, so that the differential signal can be prevented from being interfered by noise outside the signal transmission device, and the energy transmitted by the differential signals to the outside of the signal transmission device in a form of electromagnetic waves is also reduced, thereby reducing electromagnetic interference (EMI), and achieving relatively good electromagnetic compatibility (EMC) and electro-static discharge (ESD) protection effects. The signal transmission device therefore improves the transmission quality, and the transmission line can transmit the signal to the electronic device more efficiently. In addition, the signal transmission device can support various existing transmission specifications, such as USB specifications, PCIe specifications, display port specifications, and HDMI specifications, so that a single signal transmission device can transmit a greater amount of data through multiplexing, and users do not need to prepare various transmission lines for different specifications so that it is very convenient for use.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A signal transmission device capable of transmitting a plurality of data streams, comprising:
a plurality of positive differential pins, wherein a first positive differential pin of the positive differential pins is configured to transmit a positive signal content of a first differential signal, and a second positive differential pin of the positive differential pins is configured to transmit a positive signal content of a second differential signal;
a plurality of negative differential pins, wherein a first negative differential pin of the negative differential pins is configured to transmit a negative signal content of the first differential signal, and a second negative differential pin of the negative differential pins is configured to transmit a negative signal content of the second differential signal;
a positive differential low-speed pin configured to transmit a positive signal content of a low-speed differential signal;
a negative differential low-speed pin configured to transmit a negative signal content of the low-speed differential signal;
a plurality of ground pins;
a plurality of power signal pins;
a plurality of control signal pins; and
a metal isolation layer, wherein
the first positive differential pin and the first negative differential pin are located on one side of a first ground pin of the ground pins, and the second positive differential pin and the second negative differential pin are located on the other side of the first ground pin, and wherein the positive differential pins and the negative differential pins are located on one side of the metal isolation layer, and the positive differential low-speed pin, the negative differential low-speed pin, and the control signal pins are located on the other side of the metal isolation layer.

2. The signal transmission device according to claim 1, wherein the second positive differential pin and the second negative differential pin are further located between the first ground pin and a second ground pin of the ground pins.

3. The signal transmission device according to claim 2, wherein the first positive differential pin and the first negative differential pin are further located between the first ground pin and a third ground pin of the ground pins.

4. The signal transmission device according to claim 1, wherein the positive differential pins and the negative differential pins are configured to transmit high-speed signals.

5. The signal transmission device according to claim 4, wherein a first positive differential high-speed pin of the positive differential pins is configured to transmit a positive signal content of a fifth differential signal, a first negative differential high-speed pin of the negative differential pins is configured to transmit a negative signal content of the fifth differential signal, a second positive differential high-speed pin of the positive differential pins is configured to transmit a positive signal content of a sixth differential signal, and a second negative differential high-speed pin of the negative differential pins is configured to transmit a negative signal content of the sixth differential signal, wherein
the control signal pins comprise a system main power enable pin, the system main power enable pin is located between the positive differential low-speed pin and the negative differential low-speed pin and the first positive differential high-speed pin, the first negative differential high-speed pin, the second positive differential high-speed pin and the second negative differential high-speed pin, and wherein the first positive differential high-speed pin and the first negative differential high-speed pin are located on one side of a tenth ground pin of the ground pins, and the second positive differential high-speed pin and the second negative differential high-speed pin are located on the other side of the tenth ground pin.

6. The signal transmission device according to claim 3, wherein the power signal pins are a plurality of low-voltage power pins and a plurality of high-voltage power pins, wherein the low-voltage power pins are configured to transmit low-voltage power signals, the high-voltage power pins are configured to transmit high-voltage power signals, and the third ground pin is located between the low-voltage power pins and the first positive differential pin and the first negative differential pin.

7. A signal transmission device capable of transmitting a plurality of data streams, comprising:
a plurality of positive differential pins, wherein a first positive differential pin of the positive differential pins is configured to transmit a positive signal content of a first differential signal, and a second positive differential pin of the positive differential pins is configured to transmit a positive signal content of a second differential signal;
a plurality of negative differential pins, wherein a first negative differential pin of the negative differential pins is configured to transmit a negative signal content of the first differential signal, and a second negative differential pin of the negative differential pins is configured to transmit a negative signal content of the second differential signal;
a positive differential low-speed pin configured to transmit a positive signal content of a low-speed differential signal;
a negative differential low-speed pin configured to transmit a negative signal content of the low-speed differential signal;
a plurality of ground pins;
a plurality of power signal pins;
a plurality of control signal pins;
a metal isolation layer;
a housing; and
an insulation member in the housing, wherein the housing is configured to receive the positive differential pins, the negative differential pins, the ground pins, the power signal pins, and the control signal pins, the housing comprises a chamfered angle, and the chamfered angle is at one side of the housing, wherein
the first positive differential pin and the first negative differential pin are located on one side of a first ground pin of the ground pins, and the second positive differential pin and the second negative differential pin are located on the other side of the first ground pin, and wherein the positive differential pins and the negative differential pins are located on one side of the metal isolation layer, and the positive differential low-speed pin, the negative differential low-speed pin, and the control signal pins are located on the other side of the metal isolation layer.

8. The signal transmission device according to claim 7, wherein the housing has a receiving space and a protruding portion, the protruding portion comprises a pair of side walls and a top wall, the top wall is connected between the pair of side walls, the pair of side walls and the top wall together form an insertion space, the insertion space is in communication with the receiving space; and wherein the insulation member is a tongue portion, the tongue portion is in the receiving space, and the positive differential pins, the negative differential pins, the ground pins, the power signal pins, and the control pins are at the tongue portion.

9. The signal transmission device according to claim 7, wherein the housing has a receiving space and a protruding portion, the receiving space is surrounded by the insulation member, the positive differential pins, the negative differential pins, the ground pins, the power signal pins, and the control pins are at an inner surface of the tongue portion, and wherein the protruding portion comprises a pair of side walls and a top wall, the top wall is connected between the pair of side walls, and the top wall and the pair of side walls together form an insertion space.

10. A signal transmission device capable of transmitting a plurality of data streams, comprising:
a plurality of positive differential pins configured to transmit positive signal contents of a plurality of differential signals;
a plurality of negative differential pins configured to transmit negative signal contents of the differential signals;
a positive differential low-speed pin configured to transmit a positive signal content of a low-speed differential signal;
a negative differential low-speed pin configured to transmit a negative signal content of the low-speed differential signal;
a plurality of ground pins;
a plurality of power signal pins;
a plurality of control signal pins,
a metal isolation layer, wherein the positive differential pins and the negative differential pins are located on one side of the metal isolation layer, and the positive differential low-speed pin, the negative differential low-speed pin, and the control signal pins are located on the other side of the metal isolation layer, and wherein the positive differential pins, the negative differential pins, a plurality of positive differential high-speed pins, and a plurality of negative differential high-speed pins are arranged side by side by using the metal isolation layer; and
a housing having a receiving space and a protruding portion, wherein the positive differential pins, the negative differential pins, the ground pins, the power signal pins, and the control signal pins are located at an inner surface of the housing, and wherein the protruding portion comprises a pair of side walls and a top wall, the top wall is connected between the pair of side walls, the pair of side walls and the top wall together form an insertion space, and the insertion space is in communication with the receiving space.
